(19) United States
(12) Patent Application Publication
(10) Pub. No.: US 2016/0253035 A1
(43) Pub. Date: Sep. 1, 2016

(54) LAMINATE FOR TOUCH PANEL AND FLAT PANEL DISPLAY

(71) Applicant: FUJIFILM Corporation, Tokyo (JP)

(72) Inventors: Yasuhiro MITAMURA, Kanagawa (JP); Michihiro SHIBATA, Kanagawa (JP); Reiji HIGUCHI, Kanagawa (JP)

(73) Assignee: FUJIFILM Corporation, Tokyo (JP)

(21) Appl. No.: 15/151,633

(22) Filed: May 11, 2016

Related U.S. Application Data
(63) Continuation of application No. PCT/JP2014/083103, filed on Dec. 15, 2014.

(30) Foreign Application Priority Data
Jan. 17, 2014 (JP) 2014-007155

(51) Int. Cl. G06F 3/041; C09J 133/08; B32B 27/08; B32B 27/30; G06F 3/044; B32B 7/12

(52) U.S. Cl. CPC G06F 3/0416; G06F 3/044; G06F 3/0414; G06F 3/0412; B32B 7/12; B32B 27/08; B32B 27/308; C09J 133/08; G06F 2203/04103; G06F 2203/04112; B32B 2457/20; B32B 2457/208

(57) ABSTRACT

A laminate for a touch panel suppresses false operation through a wide range of temperatures. A flat panel display includes the laminate. The laminate includes an adhesive layer, and a capacitance touch panel sensor, in which the adhesive layer includes a poly(meth)acrylate which is formed by polymerizing (meth)acrylate and which has a polycyclic aliphatic hydrocarbon group and a saturated chain hydrocarbon group, the (meth)acrylate compound includes at least one type or 2 or more types of (meth)acrylate X which is represented by Formula (X) and which has a polycyclic aliphatic hydrocarbon group with 7 to 30 carbon atoms and one type or 2 or more types of (meth)acrylate Y which is represented by Formula (Y) and which has a saturated chain hydrocarbon group with 8 to 30 carbon atoms, and a temperature dependency of relative permittivity of the adhesive layer and a maximum value of relative permittivity are predetermined values.

### CROSS-REFERENCE TO RELATED APPLICATIONS

This application is a Continuation of PCT International Application No. PCT/JP2014/083103 filed on Dec. 15, 2014, which claims priority under 35 U.S.C. §119(a) to Japanese Patent Application No. 2014-007155 filed on Jan. 17, 2014. The above application is hereby expressly incorporated by reference, in its entirety, into the present application.

### BACKGROUND OF THE INVENTION

1. Field of the Invention

The present invention relates to a laminate for a touch panel and specifically relates to a laminate for a touch panel which comprises an adhesive layer which includes a poly(meth)acrylate which is obtained by polymerizing a predetermined (meth)acrylate.

In addition, the present invention also relates to a flat panel display which includes the laminate for a touch panel.

2. Description of the Related Art

In recent years, the number of touch panels mounted on mobile phones, mobile game devices, and the like has increased and, specifically, a capacitance touch panel which is capable of multiple-point detection has attracted attention.

In general, when manufacturing flat panel displays such as touch panels, an adhesive sheet (an optical adhesive film) used for transparent visibility is used in order to closely attach between each member of a display apparatus, a touch panel sensor, and the like, and various types of adhesive sheets have been proposed. As such adhesive sheets, adhesive sheets with high relative permittivity have been proposed in order to obtain a high light transmitting property and improve the touch sensitivity. For example, JP2012-140605A discloses an adhesive sheet with a relative permittivity of a predetermined value or more in order to suppress decreases in the detection sensitivity in a capacitance touch panel.

### SUMMARY OF THE INVENTION

On the other hand, there is a demand for touch panels which do not generate false operations in various types of usage environments such as cold places or warm places.

The present inventors discovered that there is a problem in that false operations frequently occur in low temperature environments or high temperature environments in cases of manufacturing touch panels using the pressure sensitive adhesive described in JP2012-140605A.

In consideration of the circumstances described above, the present invention has an object of providing a laminate for a touch panel which is able to suppress the generation of false operations in a touch panel in environments having a wide range of temperatures from low temperatures to high temperatures.

In addition, the present invention also has an object of providing a flat panel display which includes the laminate for a touch panel.

As a result of intensive research regarding the problem described above, the present inventors discovered that using an adhesive layer which includes a poly(meth)acrylate which is obtained using a predetermined (meth)acrylate compound as pressure sensitive adhesive exhibits the desired effects.

That is, it was discovered that it is possible to achieve the object described above through the following configuration.

(1) A laminate for a touch panel comprising an adhesive layer, and a capacitance touch panel sensor,

in which the adhesive layer includes a poly(meth)acrylate which is formed by polymerizing a (meth)acrylate compound and which has a polycyclic aliphatic hydrocarbon group and a saturated chain hydrocarbon group,

the (meth)acrylate compound includes at least one type or two or more types of (meth)acrylate X which is represented by Formula (X) and which has a polycyclic aliphatic hydrocarbon group with 7 to 30 carbon atoms and one type or two or more types of (meth)acrylate Y which is represented by Formula (Y) and which has a saturated chain hydrocarbon group with 8 to 30 carbon atoms,

a content of the (meth)acrylate X is 25 mass % to 41 mass % with respect to the total mass of the (meth)acrylate compound,

a content of the (meth)acrylate Y is 58 mass % to 70 mass % with respect to the total mass of the (meth)acrylate compound,

an ester group mass ratio EX which is represented by Equation (1) described below is 5 mass % to 9 mass %,

an ester group mass ratio EY which is represented by Equation (2) described below is 12 mass % to 18 mass %,

an acid value and a hydroxyl number of the poly(meth)acrylate is 0 mgKOH/g,

the poly(meth)acrylate does not include a urethane bond, a urea bond, an amide bond, or an alkyl substituted amino group,

the adhesive layer does not include polyurethane and polyurea, and

a temperature dependency of relative permittivity of the adhesive layer which is obtained from a temperature dependency evaluation test described below is 30% or less, and a maximum value of relative permittivity at each temperature every 20° C. from −40° C. to 80° C. is 3.5 or less.

(2) The laminate for a touch panel according to (1), in which the total ratio (ΣRep) of tertiary carbon atoms and quaternary carbon atoms which are included in a cyclic structure in the polycyclic aliphatic hydrocarbon group and which is represented by Equation (3) to be described below is 0.29 to 0.37, and

the total ratio (ΣRbc) of tertiary carbon atoms and quaternary carbon atoms which are included in the saturated chain hydrocarbon group and which is represented by Equation (4) to be described below is 0.04 to 0.12.

(3) The laminate for a touch panel according to (1) or (2),

in which in Formula (X), R₂ represents a polycyclic aliphatic hydrocarbon group of which carbon atoms which are bonded with oxygen atoms which are adjacent to R₂ are tertiary carbon atoms or quaternary carbon atoms,

the (meth)acrylate Y includes (meth)acrylate Z in which R₄ is a straight-chain alkyl group with 8 to 30 carbon atoms and (meth)acrylate W in which R₄ is a branched chain alkyl group with 8 to 30 carbon atoms, and

in the (meth)acrylate Z, an alkylene group which is represented by —(CH₂—)ₘ— is included between tertiary carbon atoms or quaternary carbon atoms which are included in the branched chain alkyl group which is represented by R₄ and oxygen atoms which are adjacent to R₄.

(4) The laminate for a touch panel according to any one of (1) to (3), in which a molar ratio of the (meth)acrylate X to the (meth)acrylate Y ((meth)acrylate X molar amount/(meth)acrylate Y molar amount) is 0.40 to 0.67.

(5) The laminate for a touch panel according to any one of (2) to (4), in which the total ratio (ΣRep) of tertiary carbon atoms and quaternary carbon atoms which are included in a cyclic structure in the polycyclic aliphatic hydrocarbon group is 0.34 to 0.37.

(6) The laminate for a touch panel according to any one of (1) to (5), in which the adhesive layer is formed by a photocuring treatment.

(7) The laminate for a touch panel according to any one of (1) to (6), in which the capacitance touch panel sensor comprises a substrate and an electrode which is arranged at least on one surface of the substrate, and the electrode includes a mesh form which is formed of a grid which is formed by conductive thin wire.

(8) The laminate for a touch panel according to (7), in which the conductive thin wire is formed of silver thin wire.

(9) The laminate for a touch panel according to (7) or (8), in which the electrodes are arranged on both sides of the substrate.

(10) A flat panel display comprising the laminate for a touch panel according to any one of (1) to (9), and a display apparatus.

According to the present invention, it is possible to provide a laminate for a touch panel which is able to suppress the generation of false operations in a touch panel in environments having a wide range of temperatures from low temperatures to high temperatures.

In addition, according to the present invention, it is also possible to provide a flat panel display which includes the laminate for a touch panel.

### BRIEF DESCRIPTION OF THE DRAWINGS

FIG. 1 is a cross-sectional diagram of a laminate for a touch panel of the present invention.

FIG. 2 is a schematic diagram of a sample for evaluation used in a temperature dependency evaluation test.

FIG. 3 shows an example of results of the temperature dependency evaluation test.

FIG. 4 is a cross-sectional diagram of another embodiment of the laminate for a touch panel of the present invention.

FIG. 5 is a cross-sectional diagram of a capacitance touch panel of the present invention.

FIG. 6 is a planar diagram of an embodiment of a capacitance touch panel sensor.

FIG. 7 is a cross-sectional diagram which cuts FIG. 6 along a cut line A-A.

FIG. 8 is an enlarged planar diagram of a first detection electrode.

FIG. 9 is a partial cross-sectional diagram of another embodiment of the capacitance touch panel sensor.

FIG. 10 is a partial cross-sectional diagram of another embodiment of the capacitance touch panel sensor.

FIG. 11 is a partial cross-sectional diagram of another embodiment of the capacitance touch panel sensor.

FIG. 12 is a cross-sectional diagram which cuts FIG. 11 along a cut line A-A.

### DESCRIPTION OF THE PREFERRED EMBODIMENTS

Description will be given below of favorable aspects of the laminate for a touch panel of the present invention with reference to the diagrams.

Here, in the present specification, (meth)acrylate refers to a concept which includes both acrylate and methacrylate. In addition, (meth)acrylate (or (meth)acrylate compound) has the meaning of a compound (a monomer) which includes a (meth)acryloyl group. In addition, a (meth)acryloyl group refers to a concept which includes both an acryloyl group and a methacryloyl group. In addition, poly(meth)acrylate has the meaning of a concept which includes both polyacrylate and polymethacrylate.

Furthermore, numeric value ranges which are represented using “to” in the present specification are ranges which include the numeric values which are described before and after “to” as the lower limit value and the upper limit value.

Here, one feature of the laminate for a touch panel of the present invention is that the type and usage amount of a (meth)acrylate compound which forms poly(meth)acrylate which functions as pressure sensitive adhesive is controlled.

Currently, equipment in which a touch panel is mounted has been developed from mobile applications to PCs, medium-size displays, automotive display apparatuses, and the like and, as a result, as the electrodes in touch sensors, in addition to ITO wiring, metal meshes and the like with a lower resistance are also used. On the other hand, regarding poly(meth)acrylate-based pressure sensitive adhesive which is used in the prior art, a great number of carbonyl groups which have a strong dipole-dipole moment are present in the structure thereof and, due to the flexibility thereof, variations in the total amount of the dipole-dipole moment due to the temperature are increased and false operations are easily generated depending on the environment in which the touch panel is used. In particular, there is an increased concern over false operations in a case of a metal mesh with lower resistance.

It is assumed that the relative permittivity of poly(meth)acrylate is governed by the molar molecular weight or polarizability of the molecules which contribute to the dipole moment. Thus, in the present invention, it was discovered that, when producing the poly(meth)acrylate which is included in an adhesive layer, the desired effects are obtained by limiting the usage amounts of the various types of (meth)acrylate used, the amount of an ester portion (—C(═O)O—), the structural factor of the hydrocarbon group, and the like.

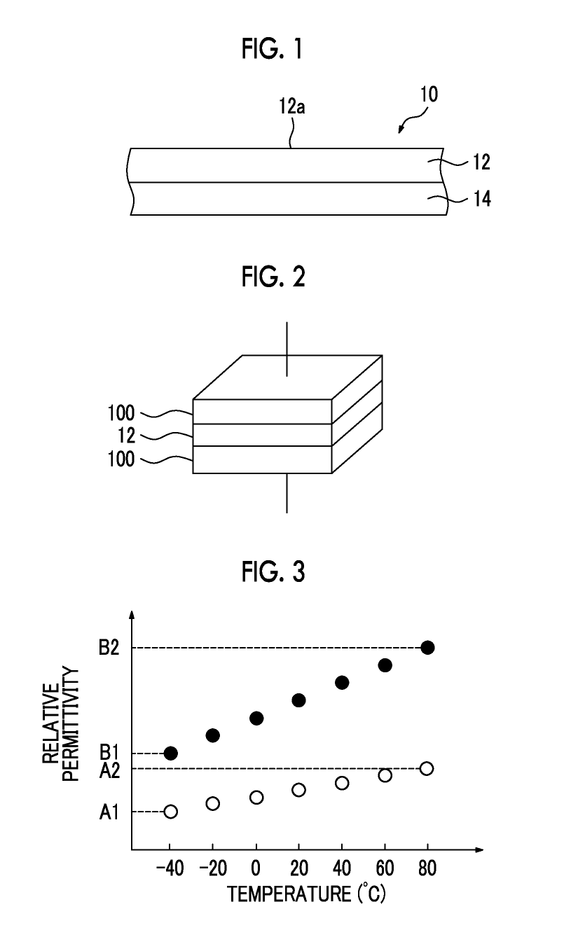

FIG. 1 is a cross-sectional diagram of a first embodiment of the laminate for a touch panel of the present invention.

As shown in FIG. 1, a laminate for a touch panel 10 comprises an adhesive layer 12 and a capacitance touch panel sensor 14 which is adjacent to the adhesive layer 12. A surface 12a of the adhesive layer 12 on the opposite side to the capacitance touch panel sensor 14 side is able to be closely attached to another member. Here, as shown in FIG. 1, the adhesive layer 12 is preferably an adhesive film without a base material and which is used for transparent visibility. That is, an adhesive film where a base material (a base material which does not exhibit adhesiveness) is not included in the adhesive layer 12 is preferable. In addition, as will be described below, the laminate for a touch panel 10 shown in FIG. 1 is used for touch panel applications (specifically, a capacitance touch panel).

Detailed description will be given below of each member of the laminate for a touch panel 10. First, detailed description of the adhesive layer 12 will be given below.

<Adhesive Layer>

The adhesive layer 12 is a layer which is used for securing adhesiveness between members.

Regarding the adhesive layer 12, the temperature dependency of the relative permittivity which is obtained from the temperature dependency evaluation test which will be described below is 30% or less. Among these, in terms of false operations being less easily generated in the touch panel (also simply referred to below as “in terms of the effects of the present invention being better”), 25% or less is preferable, and 20% or less is more preferable. The lower limit is not particularly limited; however, a lower lower limit is more preferable, and 0% is most preferable.

In a case where the temperature dependency of the relative permittivity exceeds 30%, false operations are easily generated in the touch panel.

Detailed description will be given below of a method for carrying out the temperature dependency evaluation test. Here, the measurement of the relative permittivity which uses an impedance measurement technique at each temperature and which will be described below is generally known as a capacitance method. Conceptually, the capacitance method is a method for forming a capacitor by interposing a sample between electrodes and calculating the permittivity from the measured capacitance value. In addition, since electronic equipment such as touch panels is inevitably used outside along with growth of the “ubiquitous society” which is developing along with the mobilization of electronic equipment on which capacitance touch panel are mounted, the environmental temperatures to which the electronic equipment is exposed were assumed to be −40° C. to 80° C. and, in the present evaluation test, the test environments were −40° C. to 80° C.

Firstly, as shown in FIG. 2, a sample for evaluation is produced by interposing the adhesive layer 12 (thickness: 100 μm to 500 μm) which is a measurement target between a pair of aluminum electrodes 100 (electrode area: 20 mm×20 mm) and carrying out a pressurized defoaming treatment at 40° C. at 5 atm for 60 minutes.

After that, the temperature of the adhesive layer in the sample for evaluation is increased by 20° C. from 40° C. to 80° C. in stages and a capacitance C is obtained by impedance measurement at 1 MHz using an impedance analyzer (4294A manufactured by Agilent Technologies Inc.) at each temperature. After that, after multiplying the obtained capacitance C by a thickness T of the adhesive layer, the obtained value is divided by the product of an area S of an aluminum electrode and a vacuum permittivity ε₀ (8.854×10⁻¹² F/m) and the relative permittivity is calculated. That is, the relative permittivity is calculated by Equation (X): relative permittivity=(capacitance C×thickness T)/(area S×vacuum permittivity ε₀).

In more detail, the temperature is increased in stages such that the temperatures of the adhesive layer are −40° C., −20° C., 0° C., 20° C., 40° C., 60° C., and 80° C. and after leaving the adhesive layer for 5 minutes until the temperature thereof is stabilized at each temperature, the capacitance C is obtained by impedance measurement at 1 MHz at the particular temperature and the relative permittivity at each temperature is calculated from the obtained value.

Here, the thickness of the adhesive layer is a value which is obtained by measuring the thickness of the adhesive layer at at least 5 or more arbitrary points and arithmetically averaging the result.

After that, the minimum value and the maximum value are selected from the calculated relative permittivity and the ratio of the difference of the two with respect to the minimum value is obtained. In more detail, a value (%) which is calculated by the Equation [{(maximum value−minimum value)/minimum value}×100] is obtained and the value is set as the temperature dependency.

FIG. 3 shows an example of a temperature dependency evaluation test result. Here, the lateral axis in FIG. 3 indicates the temperature and the vertical axis indicates the relative permittivity. In addition, FIG. 3 is an example of the measurement results of two types of adhesive layers and one set of results is shown with white circles and the other is shown with black circles.

Referring to FIG. 3, in the adhesive layer A which is shown with the white circles, the relative permittivity at each temperature is comparatively close to each other and the change is also small. That is, the relative permittivity of the adhesive layer A indicates that the change according to the temperature is small and the relative permittivity of the adhesive layer A does not easily change even in cold places or warm places. As a result, in a touch panel which includes the adhesive layer A, the capacitance between detection electrodes is not easily shifted from the originally set value and false operations are not easily generated in the touch panel. Here, it is possible to obtain the temperature dependency (%) of the adhesive layer A by the Equation [(A2−A1)/A1×100] by selecting A1 which is the minimum value of the white circles in FIG. 3 and A2 which is the maximum value.

On the other hand, in the adhesive layer B which is shown by the black circles, as the temperature increases, the relative permittivity greatly increases and the change is large. That is, the relative permittivity of the adhesive layer B indicates that the change according to the temperature is large and the capacitance between the detection electrodes is easily shifted from the originally set value and false operations are easily generated in the touch panel. Here, it is possible to obtain the temperature dependency (%) of the adhesive layer B by the Equation [(B2−B1)/B1×100] by selecting B1 which is the minimum value of the black circles in FIG. 3 and B2 which is the maximum value.

That is, the temperature dependency described above indicates the degree of change in the permittivity according to the temperature and, when the value is small, the change in the relative permittivity is small from a low temperature (−40° C.) to a high temperature (80° C.) and false operations are not easily generated. On the other hand, when the value is large, the change in the relative permittivity is large from a low temperature (−40° C.) to a high temperature (80° C.) and false operations are easily generated in the touch panel.

In general, in a case where an insulator is present between conductors such as electrodes, the capacitance C of the insulator between electrodes is obtained by capacitance C=permittivity ε×area S=layer thickness T. Here, the permittivity ε is obtained by the permittivity ε₀ of permittivity ε=relative permittivity εᵣ×vacuum.

In a capacitance touch panel, the adhesive layer is, for example, arranged between a capacitance touch panel sensor and a protective substrate (a cover member), between a capacitance touch panel sensor and a display apparatus, or between conductive films which comprises a substrate in a capacitance touch panel sensor and detection electrodes which are arranged on the substrate, and the adhesive layer itself has a parasitic capacitance. Accordingly, an increase in the parasitic capacitance of the adhesive layer which is adjacent to a sensing section (an input region) of the capacitance touch panel sensor causes charging defects at each sensing site of a sensing section which is able to detect contact with physical matter, which may be one of the causes of false operations.

In addition, due to the increase in the areas of capacitance touch panels in recent years, the total number of grid lines (which are equivalent to the detection electrodes which will be described below) in an interface sensor section has a tendency to increase. Since it is necessary to increase the scan rate in correspondence with this increase in order to obtain an appropriate sensing sensitivity, the threshold value of the capacitance of each grid line or each sensor node is inevitably decreased. Accordingly, the influence due to the parasitic capacitance of the adhesive layer in the vicinity of the sensing section described above is relatively increased and false operations are easily generated in this environment. Accordingly, for the purpose of decreasing the parasitic capacitance of the adhesive layer which is adjacent to the sensing section described above, a means for decreasing the permittivity ε of the adhesive layer described above is adopted.

Therefore, the maximum value of the relative permittivity at each temperature every 20° C. between −40° C. and 80° C. of the adhesive layer 12 is 3.5 or less, preferably 3.3 or less, and more preferably 3.2 or less.

Here, the measurement method of the relative permittivity is the same as in the steps of the temperature dependency evaluation test described above.

The thickness of the adhesive layer 12 is not particularly limited, but is preferably 5 μm to 2500 μm and more preferably 20 μm to 500 μm. Handling is easy within the ranges described above.

Here, the adhesive layer 12 may be a layer where a plurality of adhesive layers with different constituent components are laminated. In a case of a laminated configuration, the temperature dependency of the relative permittivity is designed so as to be within the range of the present invention in a laminated state.

The adhesive layer 12 is preferably optically transparent. Being optically transparent has the meaning that the total light transmittance is 85% or more, preferably 90% or more, and more preferably 95% or more.

(Components Included in Adhesive Layer)

The adhesive layer 12 includes poly(meth)acrylate (a (meth)acryl-based polymer) which is formed by polymerizing a (meth)acrylate compound and which has a polycyclic aliphatic hydrocarbon group and a saturated chain hydrocarbon group. The poly(meth)acrylate functions as pressure sensitive adhesive.

Here, the poly(meth)acrylate is a polymer which is formed by setting a (meth)acrylate compound as a polymerizable monomer and a repeating unit which is derived from another polymerizable monomer (for example, an acrylamide compound) is not included therein. In other words, the poly(meth)acrylate is a polymer which is obtained only using a (meth)acrylate compound as a polymerizable monomer.

The (meth)acrylate compound described above includes at least one type or two or more types of (meth)acrylate X which is represented by Formula (X) and which has a polycyclic aliphatic hydrocarbon group with 7 to 30 carbon atoms below and one type or two or more types of (meth)acrylate Y which is represented by Formula (Y) and which has a saturated chain hydrocarbon group with 8 to 30 carbon atoms below. That is, the poly(meth)acrylate is a copolymer which is formed by polymerizing a (meth)acrylate compound (a (meth)acrylate monomer) which includes at least the (meth)acrylate X described above and the (meth)acrylate Y described above.

For the (meth)acrylate X and the (meth)acrylate Y, one type of each may be used or two or more types of each may be used.

Here, (meth)acrylate other than the (meth)acrylate X and the (meth)acrylate Y may be included as the (meth)acrylate compound. Examples thereof include benzyl acrylate, dicyclopentadienyloxy ethyl (meth)acrylate and the like; however, the present invention is not limited thereto.

However, a (meth)acrylate compound which imparts an acid value and a hydroxyl number to poly(meth)acrylate is not used. That is, as the (meth)acrylate compound which is used for polymerizing the poly(meth)acrylate, only (meth)acrylate compounds of which the acid value and the hydroxyl number are 0 mgKOH/g are used. As a result, the acid value and the hydroxyl number of the poly(meth)acrylate are 0 mgKOH/g.

Therefore, when polymerizing the poly(meth)acrylate, (meth)acrylate which has a carboxylic acid group or (meth)acrylate which has a hydroxyl group are not used.

Here, it is possible to calculate the acid value and the hydroxyl number according to the method which is described in JIS K0070.

That is, the acid value is indicated by the number of mg of potassium hydroxide which is necessary for neutralizing the free fatty acid, resin acid, and the like which are contained in 1 g of a sample. In addition, the hydroxyl number is indicated by the number of mg of potassium hydroxide necessary for neutralizing acetate which is bonded with a hydroxyl group when acetylating 1 g of a sample.

Here, in terms of the effects of the present invention being better, the content of (meth)acrylate X is preferably 25.0 mass % to 41.0 mass % with respect to the total mass of the (meth)acrylate compound, more preferably 27.0 mass % to 41.0 mass %, and even more preferably 38.0 mass % to 41.0 mass %.

In addition, in terms of the effects of the present invention being better, the content of (meth)acrylate Y is preferably 58.0 mass % to 70.0 mass % with respect to the total mass of the (meth)acrylate compound, more preferably 58.0 mass % to 68.0 mass %, and even more preferably 58.0 mass % to 62.0 mass %.

The molar ratio ((meth)acrylate X/(meth)acrylate Y) of the molar amount of the (meth)acrylate X to the molar amount of the (meth)acrylate Y described above is not particularly limited, but is preferably 0.39 to 0.68, more preferably 0.40 to 0.67, and even more preferably 0.60 to 0.65. Here, in a case where two or more types of compounds are used as (meth)acrylate X (and (meth)acrylate Y), the sum (the total) of the molar amount of the compound corresponding to (meth)acrylate X (and (meth)acrylate Y) is the molar amount of (meth)acrylate X (and (meth)acrylate Y).

Here, the molar ratio described above is also referred to as ΣRccal below.

Detailed description will be given below of (meth)acrylate X and (meth)acrylate Y.

((Meth)Acrylate X Represented by Formula (X))

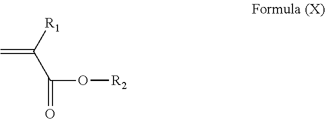

In Formula (X), R₁ represents a hydrogen atom or an alkyl group. The type of the alkyl group is not particularly limited and, in terms of synthesis, an alkyl group with 1 to 3 carbon atoms is preferable and, more specifically, examples thereof preferably include a methyl group, an ethyl group, and the like.

R₂ represents a polycyclic aliphatic hydrocarbon group (a heterocyclic hydrocarbon group) with 7 to 30 carbon atoms.

The polycyclic aliphatic hydrocarbon group has the meaning of a structure in which two or more non-aromatic rings are linked by two or more carbon atoms. In more detail, the polycyclic aliphatic hydrocarbon group is an organic group which includes carbon atoms and hydrogen atoms and which is formed by combining a plurality of cyclic structures. In general, the cyclic structures which are linked together have a structural relationship mutually inhibiting conformational transition. As an example of the polycyclic aliphatic hydrocarbon group, a dicycloheptyl group can be regarded as a geometrically three cyclic structure as shown below; however, conformational transition such as in a monocyclic alicyclic group is substantially inhibited due to the mutual cross-linking structure.

Here, a group which is formed by a structure in which an aromatic ring such as a naphthyl group is condensed is not included in the polycyclic aliphatic hydrocarbon group.

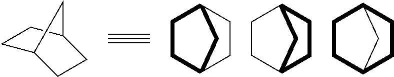

Examples of the polycyclic aliphatic hydrocarbon group include a bicyclo ring structure, a tricyclo ring structure, a tetracyclo ring structure, a pentacyclo ring structure, a hexacyclo ring structure, and the like and, more specifically, specific examples of the ring structure include bicyclo[2.2.1]heptane, bicyclo[2.2.2] octane, tricyclo[5.2.1.0^{2,6}]decane, tricyclo[6.2.1.0^{2,7}]undecane, tricyclo[6.2.2.0^{2,6}]undecane, tricyclo[7.2.2.0^{2,7}]dodecane, tetracyclo[7.2.1.0^{2,7}.0^{3,6}]dodecane, tetracyclo[7.2.2.1^{2,7}.0^{3,6}]dodecane, tetracyclo[7.2.2.2^{3,6}.0^{2,7}]tridecane skeleton, and the like. In other words, examples thereof include adamantane, norbornane, norbornene, methyl norbornane, ethyl norbornane, methyl norbornene, ethyl norbornene, isobornane, tricyclodecane, tetracyclododecane, and the like.

The number of carbon atoms of the polycyclic aliphatic hydrocarbon group is 7 to 30 and, in terms of effects of the present invention being better, 7 to 20 is preferable, and 9 to 16 is more preferable.

Regarding the poly(meth)acrylate which is obtained by polymerizing a (meth)acrylate compound which includes the (meth)acrylate X described above, an ester group mass ratio EX which is represented by Equation (1) below is 5.0 mass % to 9.0 mass %, preferably 6.0 mass % to 9.0 mass %, and more preferably 8.0 mass % to 9.0 mass %.

Equation (1) indicates the content ratio of an ester group (—C(═O)O—) which is derived from (meth)acrylate X in the poly(meth)acrylate. As described above, the ester group in (meth)acrylate X has a large dipole-dipole moment and the effects of the present invention are obtained by adjusting the content thereof within the ranges described above.

$$EX ( \% ) = {\sum }_{i = 1}^{n} ( RXi \times WXi ) \qquad Equation ( 1 )$$

In Equation (1), n represents the number of types of (meth)acrylate X and RXi indicates a ratio (molecular weight of ester group/total molecular weight of i-th (meth)acrylate X) of the molecular weight of an ester group (—COO—) in the i-th (meth)acrylate X with respect to the total molecular weight of the (meth)acrylate X of the i-th type. WXi indicates a mass ratio (%) of the i-th (meth)acrylate X with respect to the total mass of the (meth)acrylate compound.

For example, the ratio (molecular weight of ester group/total molecular weight of isobornyl acrylate) of isobornyl acrylate which is represented by the formula below is obtained by the equation below.

The ratio is obtained as (molecular weight of ester group/total molecular weight of (meth)acrylate X): 44/208=0.211.

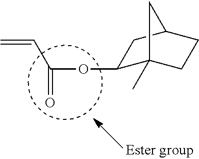

In addition, for example, in a case where three types (X1, X2, and X3) of (meth)acrylate X are used, the ester group mass ratio EX which is represented by Equation (1) is obtained by the equation below. Here, a ratio of molecular weight and a mass ratio of each of the (meth)acrylates X1 to X3 is represented by RX1 to RX3 and WX1 to WX3.

Ester group mass ratio EX=(RX1×RW1)+(RX2×RW2)±(RX3×RW3)

In terms of the effects of the present invention being better, tertiary carbon atoms and/or quaternary carbon atoms are preferably included in the polycyclic aliphatic hydrocarbon group.

Among these, the ratio (Ne/Np) of the total number (Ne) of tertiary carbon atoms and quaternary carbon atoms which are included in the cyclic structure of the polycyclic aliphatic hydrocarbon group with respect to the total number of carbon atoms (Np) which are included in the polycyclic aliphatic hydrocarbon group is preferably 0.30 to 0.36 and more preferably 0.32 to 0.35.

However, in Formula (X), the total number (Ne) described above does not include tertiary carbon atoms or quaternary carbon atoms which are carbon atoms which are included in R₂ and bonded to oxygen atoms which are adjacent to R₂. An example is given below. The carbon atoms which are indicated by an arrow a and an arrow b shown in the diagram below correspond to the “tertiary carbon atoms or quaternary carbon atoms which are included in the cyclic structure in the polycyclic aliphatic hydrocarbon group” described above; however, the carbon atom which is adjacent to an oxygen atom which is indicated by an arrow c does not correspond to the “tertiary carbon atoms or quaternary carbon atoms which are included in the cyclic structure in the polycyclic aliphatic hydrocarbon group” described above.

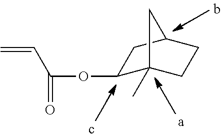

Detailed description will be given below of tertiary carbon atoms and quaternary carbon atoms which are included in the cyclic structure in the polycyclic aliphatic hydrocarbon group.

The tertiary carbon atoms and quaternary carbon atoms are included in the cyclic structure. For example, the carbon atoms which are indicated by arrows in the diagram below correspond to tertiary carbon atoms which are included in the cyclic structure. Thus, in a case of the compound group below, the total number of carbon atoms (Np) is 7, the total number (Ne) of the tertiary carbon atoms and quaternary carbon atoms is 2, and the ratio (Ne/Np) is calculated as 0.286.

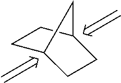

An example of a group which includes tertiary carbon atoms and quaternary carbon atoms will be shown below.

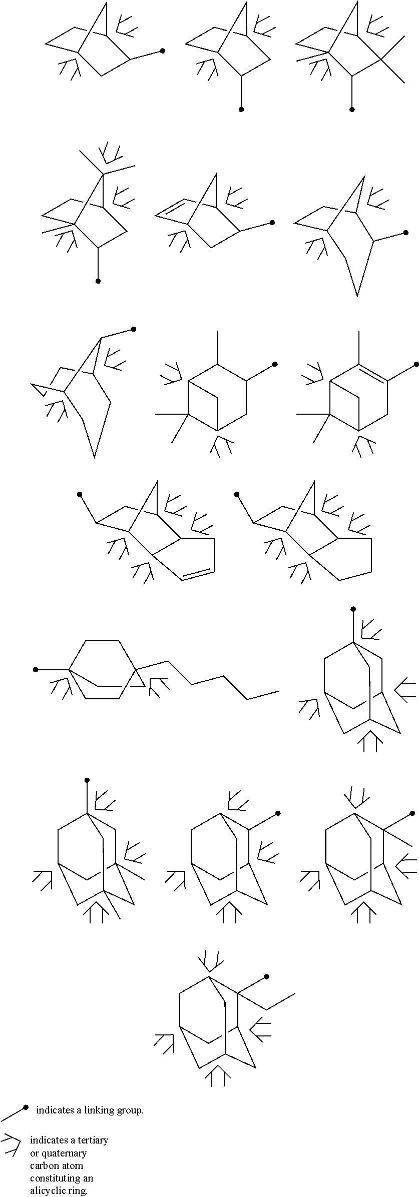

In addition, the total ratio (ΣRep) of the tertiary carbon atoms and quaternary carbon atoms which are included in the cyclic structure in the polycyclic aliphatic hydrocarbon group in the poly(meth)acrylate is obtained by Equation (3) below and, in terms of the effects of the present invention being better, 0.29 to 0.37 is preferable, 0.30 to 0.37 is more preferable, and 0.34 to 0.37 is even more preferable.

$$\sum Rep = {\sum }_{i = 1}^{n} ( PXi \times MXi ) \qquad Equation ( 3 )$$

In Equation (3), n represents the number of types of (meth)acrylate X and PXi indicates a ratio (Ne/Np) of (meth)acrylate X of the i-th type. MXi indicates the molar ratio (molar amount of i-th (meth)acrylate X/total molar amount of (meth)acrylate X) of the i-th (meth)acrylate X with respect to the total molar amount of (meth)acrylate X.

For example, in a case where two types of (meth)acrylate X are used and the ratio (Ne/Np) of one (meth)acrylate X is 0.1 and a molar ratio (MX1) is 0.6 and the ratio (Ne/Np) of the other (meth)acrylate X is 0.2 and a molar ratio (MX2) is 0.4, the total ratio described above is calculated as (0.1×0.6)±(0.2×0.4)=0.14.

In terms of the effects of the present invention being better, examples of one favorable aspect of (meth)acrylate X include an aspect in which R₂ represents a polycyclic aliphatic hydrocarbon group in which the carbon atoms which are bonded with oxygen atoms which are adjacent to R₂ are tertiary carbon atoms or quaternary carbon atoms in Formula (X). In more detail, the carbon atom in R₂ which is bonded with an oxygen atom which is adjacent to R₂ which is indicated by an arrow in the diagram below is a tertiary carbon atom or a quaternary carbon atom. Examples of (meth)acrylate X with this aspect include isobornyl acrylate, dicyclopentanyl acrylate, and the like.

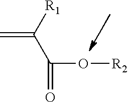

((Meth)Acrylate Y Represented by Formula (Y))

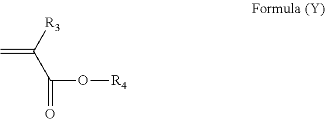

In Formula (Y), R₃ represents a hydrogen atom or an alkyl group. The definition of the alkyl group is the same as the alkyl group which is represented by R₁ described above.

R₄ represents a saturated chain hydrocarbon group with 8 to 30 carbon atoms. The saturated chain hydrocarbon group is a group which is formed by carbon atoms and hydrogen atoms and is a straight-chain form or a branched chain form. Here, a cyclic form is not included.

The number of carbon atoms of the saturated chain hydrocarbon group is 8 to 30 and, in terms of the effects of the present invention being better, 8 to 22 is preferable, and 8 to 18 is more preferable.

An example of the saturated chain hydrocarbon group will be shown below. Here, • in the diagram below indicates a bonding position.

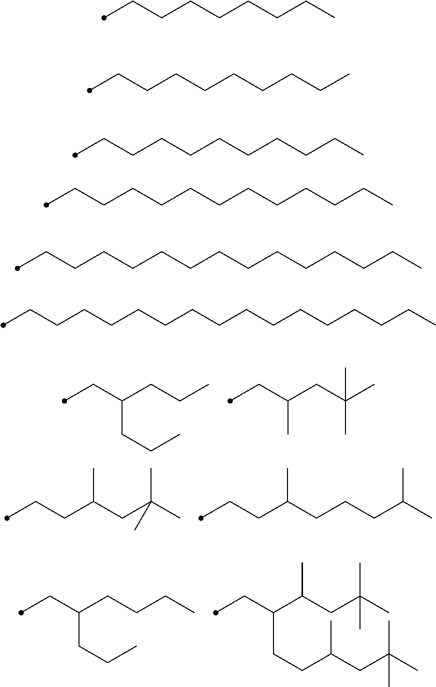

Regarding poly(meth)acrylate which is obtained by polymerizing a (meth)acrylate compound which includes the (meth)acrylate Y described above, an ester group mass ratio EY which is represented by Equation (2) below is 12.0 mass % to 18.0 mass %, preferably 13.0 mass % to 17.0 mass %, and more preferably 13.0 mass % to 14.0 mass %.

Equation (2) indicates a content ratio of an ester group (—C(═O)O—) which is derived from (meth)acrylate Y in the poly(meth)acrylate. As described above, the ester group in (meth)acrylate Y has a large dipole-dipole moment and the effects of the present invention are obtained by adjusting the content thereof within the ranges described above.

$$EY ( \% ) = {\sum }_{i = 1}^{m} ( RYi \times WYi ) \qquad Equation ( 2 )$$

In Equation (2), m represents the number of types of the (meth)acrylate Y and RYi indicates the ratio (molecular weight of ester group/total molecular weight of i-th (meth)acrylate Y) of the molecular weight of the ester group (—COO—) in the i-th (meth)acrylate Y with respect to the total molecular weight of the (meth)acrylate Y of the i-th type. WYi indicates the mass ratio (%) of the i-th (meth)acrylate Y with respect to the total mass of the (meth)acrylate compound.

In terms of the effects of the present invention being better, tertiary carbon atoms and/or quaternary carbon atoms are preferably included in the saturated chain hydrocarbon group.

Among these, the ratio (Nb/Nc) of the total number (Nb) of tertiary carbon atoms and quaternary carbon atoms which are included in the saturated chain hydrocarbon group with respect to the total number of carbon atoms (Nc) which are included in the saturated chain hydrocarbon group is preferably 0 to 0.28 and more preferably 0.05 to 0.15.

Detailed description will be given below of tertiary carbon atoms and quaternary carbon atoms which are included in the saturated chain hydrocarbon group.

Tertiary carbon atoms and quaternary carbon atoms are included in the saturated chain hydrocarbon group. For example, the carbon atoms which are indicated by arrows in the diagram below correspond to tertiary carbon atoms or quaternary carbon atoms. Thus, in a case of the group below, the total number of carbon atoms (Nc) is 9, the total number (Nb) of the tertiary carbon atoms and quaternary carbon atoms is 2, and the ratio (Nb/Nc) is calculated as 0.222. Here, • in the diagram below indicates a bonding position.

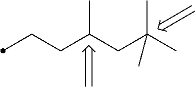

In addition, the total ratio (ΣRbc) of the tertiary carbon atoms and quaternary carbon atoms which are included in the saturated chain hydrocarbon group in the poly(meth)acrylate is obtained by Equation (4) below and, in terms of the effects of the present invention being better, 0.04 to 0.12 is preferable, 0.05 to 0.11 is more preferable, and 0.09 to 0.11 is even more preferable.

$$\sum Rbc = {\sum }_{i = 1}^{m} ( PYi \times MYi ) \qquad Equation ( 4 )$$

In Equation (4), m represents the number of types of the (meth)acrylate Y and PYi indicates the ratio (Nb/Nc) of the (meth)acrylate Y of the i-th type. MYi indicates a molar ratio (molar amount of i-th (meth)acrylate Y/total molar amount of (meth)acrylate Y) of i-th (meth)acrylate Y with respect to the total mass of (meth)acrylate Y.

Here, the calculation method in Equation (4) is carried out in the same manner as the calculation method of Equation (3) described above.

Examples of a favorable aspect of (meth)acrylate Y include an aspect in which the (meth)acrylate Y includes (meth)acrylate Z in which R₄ in Formula (Y) is a straight-chain alkyl group with 8 to 30 carbon atoms and (meth)acrylate W in which R₄ in Formula (Y) is a branched chain alkyl group with 8 to 30 carbon atoms. Including two types of chain (meth)acrylate in this manner makes the effects of the present invention better.

A favorable aspect of the number of carbon atoms of the straight-chain alkyl group described above has the same definition as the favorable aspect of the number of carbon atoms of the polycyclic aliphatic hydrocarbon group described above. In addition, a favorable aspect of the number of carbon atoms of the branched chain alkyl group described above has the same definition as the favorable aspect of the number of carbon atoms of the saturated chain hydrocarbon group described above.

Tertiary carbon atoms and/or quaternary carbon atoms which may be a branch point are included in the branched chain alkyl group described above. The total number of the tertiary carbon atoms and quaternary carbon atoms in the branched chain alkyl group is not particularly limited; however, in terms of the effects of the present invention being better, 1 to 4 is preferable.

In addition, in (meth)acrylate Z, in terms of the effects of the present invention being better, an alkylene group which is represented by —(CH₂)ₘ— is preferably included between a tertiary carbon atom or a quaternary carbon atom which is included in the branched chain alkyl group which is represented by R₄ and an oxygen atom which is adjacent to R₄. In more detail, for example, in a case where one tertiary carbon atom is included in R₄, as represented in the diagram below, an alkylene group which is represented by —(CH₂)ₘ— is preferably included between the tertiary carbon atom which is indicated by an arrow and the oxygen atom which is indicated by an arrow. Here, in the diagram below, X₁ and X₂ represent an alkyl group with 1 or more carbon atoms.

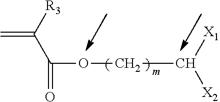

In addition, in a case where the (meth)acrylate Y includes the (meth)acrylate Z and the (meth)acrylate W described above, the mass ratio (mass of (meth)acrylate Z/mass of (meth)acrylate W) of (meth)acrylate Z to (meth)acrylate W is not particularly limited; however, in terms of the effects of the present invention being better, 0.1 to 0.9 is preferable, and 0.2 to 0.8 is more preferable.

A urethane bond, a urea bond, an amide bond, and an alkyl substituted amino group are not included in the poly(meth)acrylate described above.

The urethane bond indicates, for example, the bond in the formula below which is formed by carbonate and amine, or isocyanate and alcohol.

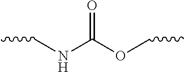

The urea bond is a group which is formed by a carbonyl group and two amino groups and indicates, for example, the bond which is represented by the formula below.

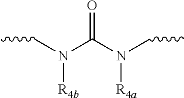

An R₄ₐ group and an R_{4b} group each independently represent a hydrogen atom or a functional group which is a functional group which may form a covalent bond with a nitrogen atom and which does not easily cause detachment or decomposition in a urea bond forming reaction. The R₄ₐ group and the R_{4b} group may bond with each other to form a cyclic structure.

The amide bond has the meaning of a bond which is represented by >N—CO— and examples thereof specifically include the group below.

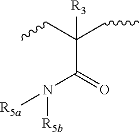

The definition of the R₃ group is the same as described above. The R₅ₐ group and R_{5b} group each independently represent a hydrogen atom or a functional group which is a functional group which may form a covalent bond with a nitrogen atom and which does not easily cause detachment or decomposition in an amide bond forming reaction. The R₅ₐ group and the R_{5b} group may bond with each other to form a cyclic structure.

The alkyl substituted amino group has the meaning of a bond which is represented by (R)₂—N—* (R each independently represents a hydrogen atom or an alkyl group and at least one represents an alkyl group) and, for example, poly(meth)acrylate does not include a repeating unit which is derived from a compound which is represented by the formula below.

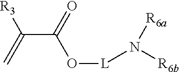

The definition of the R₃ group is the same as described above. R₆ₐ and R_{6b} each independently represent a hydrogen atom or an alkyl group and at least one represents an alkyl group. L represents a divalent linking group (for example, an alkylene group). The R₆ₐ group and the R_{6b} group may bond with each other to form a cyclic structure.

Here, it is possible to detect a urethane bond, a urea bond, an amide bond, and an alkyl substituted amino group using the IR spectrum or NMR spectrum.

Here, polyurethane and polyurea are not included in the adhesive layer described above. Polyurethane is a polymer which includes a urethane bond in a repeating unit and polyurea is a polymer which includes a urea bond in a repeating unit.

(Method for Manufacturing Adhesive Layer)

A method for manufacturing the adhesive layer 12 described above is not particularly limited; however, manufacturing is possible using a method which is known in the art. Examples thereof include a method for forming the adhesive layer 12 by coating a (meth)acryl-based pressure sensitive adhesive composition (also simply referred to below as a “composition”) which includes the (meth)acrylate compound described above on a predetermined base material (for example, a release film) and carrying out a curing treatment thereon. In addition, the adhesive layer 12 may be formed by coating an adhesive layer forming composition which includes poly(meth)acrylate on a base material after producing (meth)acrylate by firstly polymerizing the (meth)acrylate compound described above. A release film may be laminated on an exposed surface of the formed adhesive layer 12 as necessary after forming the obtained adhesive layer 12.

Detailed description will be given below of a method using the composition described above.

The composition may include other components than a (meth)acrylate compound.

For example, the composition may include a polymerization initiator as necessary. The type of the polymerization initiator is not particularly limited and the most suitable polymerization initiators are selected according to the type of curing treatment and, for example, a heat polymerization initiator or a photoinitiator may be selected. In more detail, examples of the polymerization initiator include a benzoin alkyl ether derivative, a benzophenone derivative, an α-amino alkyl phenone-based polymerization initiator, an oxime ester derivative, a thioxanthone derivative, an anthraquinone derivative, an acyl phosphine oxide derivative, a glyoxy ester derivative, an organic peroxide-based polymerization initiator, a trihalomethyl triazine derivative, a titanocene derivative, and the like.

The content of the polymerization initiator is not particularly limited; however, in terms of the polymerization of a (meth)acrylate compound efficiently proceeding, 1 part by mass to 5 parts by mass with respect to 100 parts by mass of the (meth)acrylate compound is preferable.

The composition may include a solvent as necessary. Examples of the solvents to be used include water, organic solvents (for example, alcohols such as methanol, ketones such as acetone, amides such as formamide, sulfoxides such as dimethyl sulfoxide, esters such as ethyl acetate, ethers, and the like), or a mixed solvent thereof.

Other than the above, it is possible to appropriately add various types of additive agents known in the art such as a surface lubricant, a levelling agent, an antioxidant, a corrosion inhibitor, a photostabilizer, an ultraviolet absorber, a polymerization inhibitor, a silane coupling agent, an inorganic or organic filler, powders such as metal powders and pigment powders, particulates, and foil to the composition according to the purpose of usage.

Examples of methods for coating the composition include a gravure coater, a comma coater, a bar coater, a knife coater, a die coater, a roll coater, and the like.

In addition, examples of curing treatments include a heat curing treatment, a photocuring treatment, and the like and, in terms of the effects of the present invention being better, a photocuring treatment is preferable.

The photocuring treatment may be formed by a plurality of curing steps and the light wavelength to be used may be appropriately selected from a plurality of wavelengths. In addition, the heat curing treatment may also be formed by a plurality of curing steps and the method for applying heat may be selected from appropriate methods such as an oven, a reflow oven and IR heater. Furthermore, the photocuring treatment and the heat curing treatment may be appropriately combined.

Here, it is also possible to use a method of transferring an adhesive layer onto a release film after producing the adhesive layer described above on a temporary support.

### <Capacitance Touch Panel Sensor>

The capacitance touch panel sensor 14 is a member which functions as a sensor section of a touch panel.

The configuration of the capacitance touch panel sensor 14 is not particularly limited and the most suitable structure is selected according to the type of the touch panel, but preferably has at least a substrate and a conductive section which is arranged on at least one surface of the substrate. Here, the conductive section may be arranged on both surfaces of the substrate.

The configuration of the conductive section is not particularly limited; however, it is preferably formed by conductive thin wire and it is more preferably formed by a plurality of conductive thin wires.

The material which forms the conductive section is not particularly limited; however, examples thereof include metal or alloys such as gold (Au), silver (Ag), copper (Cu), and aluminum (Al), metal oxides such as ITO, tin oxide, zinc oxide, cadmium oxide, gallium oxide, and titanium oxide, and the like.

Detailed description will be given of favorable aspects of the capacitance touch panel sensor 14 below.

The laminate for a touch panel described above is used for a flat panel display (specifically, for touch panel usage (in particular, a capacitance touch panel)).

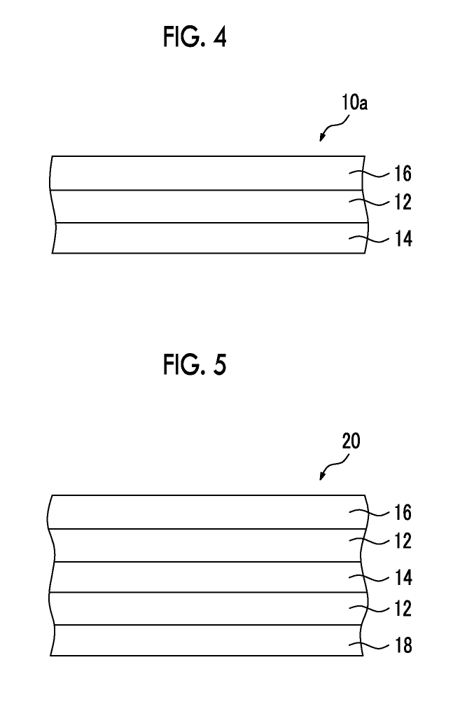

Examples of another aspect of the laminate for a touch panel include a laminate for a touch panel 10a which comprises the capacitance touch panel sensor 14, the adhesive layer 12, and a protective substrate 16 as shown in FIG. 4.

In addition, examples of favorable aspects of a capacitance touch panel which includes the laminate for a touch panel of the present invention include a capacitance touch panel 20 which comprises a display apparatus 18, the adhesive layer 12, the capacitance touch panel sensor 14, and the protective substrate 16.

Detailed description will be given below of various types of members which are used in a laminate for a touch panel and a capacitance touch panel.

(Capacitance Touch Panel Sensor)

A capacitance touch panel sensor is a sensor which is arranged on a display apparatus (on the operator side) and which detects a position of an external conductor such as human fingers using changes in capacitance generated when the external conductor such as human fingers comes into contact therewith (or comes near).

The configuration of the capacitance touch panel sensor is not particularly limited, but the capacitance touch panel sensor typically has detection electrodes (specifically, detection electrodes which extend in an X direction and detection electrodes which extend in a Y direction) and specifies the coordinates of a finger by detecting capacitance changes of the detection electrodes with which the finger is in contact or which is in vicinity of the finger.

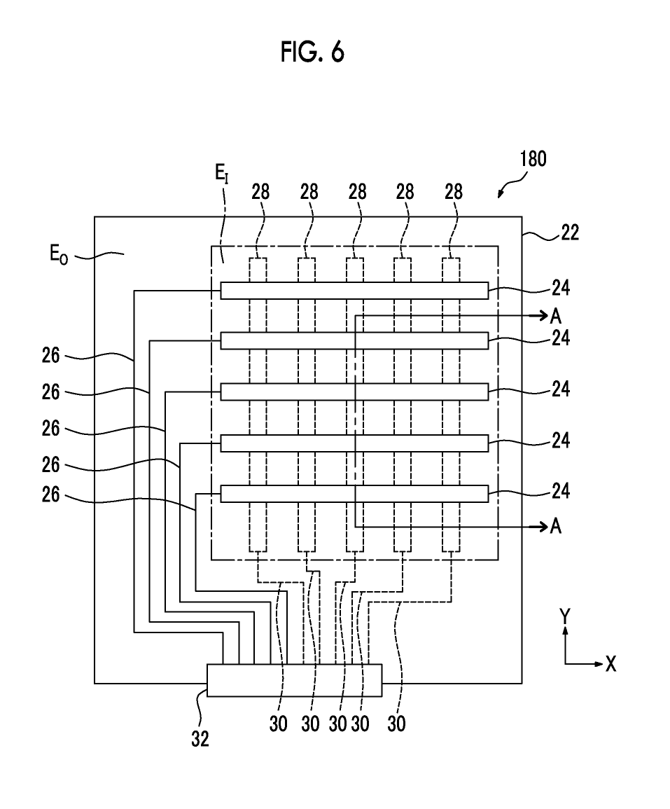

Detailed description will be given of a favorable aspect of the capacitance touch panel sensor using FIG. 6.

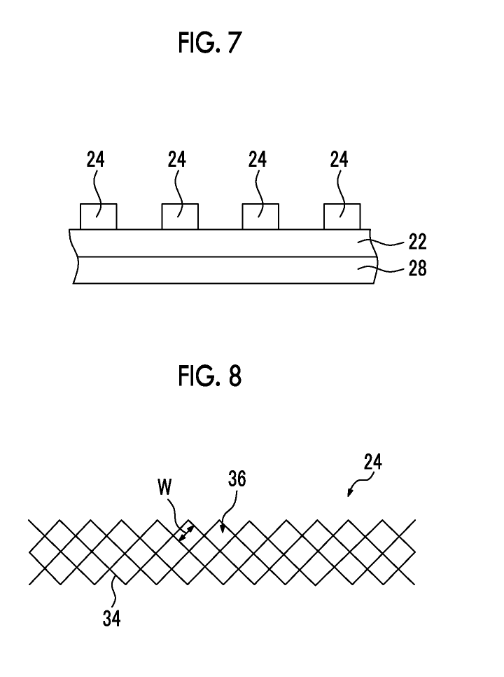

A planar diagram of a capacitance touch panel sensor 180 is shown in FIG. 6. FIG. 7 is a cross-sectional diagram which cuts FIG. 6 along a cut line A-A. The capacitance touch panel sensor 180 comprises a substrate 22, first detection electrodes 24 which are arranged on one main surface (on a front surface) of the substrate 22, first lead-out wiring 26, second detection electrodes 28 which are arranged on the other main surface (on a rear surface) of the substrate 22, second lead-out wiring 30, and a flexible printed wiring board 32. Here, a region in which there are the first detection electrodes 24 and the second detection electrodes 28 forms an input region E_{I} (an input region (a sensing section) which is able to detect a contact with an object) in which an input operation is possible by a user and the first lead-out wiring 26, the second lead-out wiring 30, and the flexible printed wiring board 32 are arranged in an outside region E_{O} which is positioned on the outside of the input region E_{I}.

Detailed description will be given below of the configuration described above.

The substrate 22 is a member which fulfills a role of supporting the first detection electrodes 24 and the second detection electrodes 28 in the input region E_{I} and fulfills a role of supporting the first lead-out wiring 26 and the second lead-out wiring 30 in the outside region E_{O}.

The substrate 22 preferably transmits light appropriately. In detail, the total light transmittance of the substrate 22 is preferably 85% to 95%.

The substrate 22 preferably has an insulation property (an insulating substrate). That is, the substrate 22 is a layer for securing the insulation property between the first detection electrodes 24 and the second detection electrodes 28.

The substrate 22 is preferably a transparent substrate (specifically, a transparent insulating substrate). Specific examples thereof include an insulating resin substrate, a ceramic substrate, a glass substrate, and the like. Among these, an insulating resin substrate is preferable for the reason of being excellent in toughness.

Examples of the material which forms the insulating resin substrate more specifically include polyethylene terephthalate, polyether sulfone, polyacryl-based resins, polyurethane-based resins, polyester, polycarbonate, polysulfone, polyamide, polyarylate, polyolefin, cellulose-based resins, polyvinyl chloride, cycloolefin-based resins, and the like. Among these, for the reason of being excellent in transparency, polyethylene terephthalate, cycloolefin-based resins, polycarbonate, and triacetyl cellulose resins are preferable.

The substrate 22 is a single layer in FIG. 6 but may be a plurality of layers such as two or more layers.

The thickness of the substrate 22 (in a case where the substrate 22 has a plurality of layers such as two or more layers, the total thicknesses thereof) is not particularly limited, but is preferably 5 μm to 350 μm and more preferably 30 μm to 150 μm. It is possible to obtain the desired visible light transmittance within the ranges described above and the handling is also easy.

In addition, the planar view shape of the substrate 22 is substantially rectangular in FIG. 6; however, the present invention is not limited thereto. For example, the shape may be circular or polygonal.

The first detection electrodes 24 and the second detection electrodes 28 are sensing electrodes which sense changes in capacitance and form a sensing section (a sensor section). That is, when a fingertip is in contact with a touch panel, the mutual capacitance between the first detection electrodes 24 and the second detection electrodes 28 changes and the position of the fingertip is calculated by an IC circuit based on the change amount.

The first detection electrodes 24 have a role of detecting the input position of a finger of a user which comes near the input region E_{I} in the X direction and have a function of generating capacitance between itself and the finger. The first detection electrodes 24 are electrodes which extend in a first direction (the X direction) and which are arranged at predetermined intervals in a second direction (the Y direction) which is orthogonal to the first direction and include a predetermined pattern as will be described below.

The second detection electrodes 28 have a role of detecting an input position of the finger of a user which comes near the input region E_{I} in the Y direction and has a function of generating capacitance in-between itself and a finger. The second detection electrodes 28 are electrodes which extend in a second direction (the Y direction) and which are arranged at predetermined intervals in the first direction (the X direction) and include a predetermined pattern as will be described below. Five of the first detection electrodes 24 and five of the second detection electrodes 28 are provided in FIG. 6; however, the number is not particularly limited as long as the number is plural.

In FIG. 6, the first detection electrodes 24 and the second detection electrodes 28 are formed by conductive thin wires. A part of an enlarged planar diagram of the first detection electrode 24 is shown in FIG. 8. As shown in FIG. 8, the first detection electrode 24 is formed by conductive thin wires 34 and includes a plurality of grids 36 formed by the intersecting conductive thin wires 34. Here, the second detection electrodes 28 also include a plurality of the grids 36 formed by the intersecting conductive thin wires 34 in the same manner as the first detection electrode 24.

Examples of the material of the conductive thin wires 34 include metal or alloy such as gold (Au), silver (Ag), copper (Cu), and aluminum (Al), metal oxide such as ITO, tin oxide, zinc oxide, cadmium oxide, gallium oxide, and titanium oxide, and the like. Among these, silver is preferable for the reason that the conductivity of the conductive thin wires 34 is excellent.

From the point of view of the adhesiveness of the conductive thin wires 34 and the substrate 22, a binder is preferably included in the conductive thin wires 34.

For the reason that the adhesiveness of the conductive thin wires 34 and the substrate 22 is better, the binder is preferably a water-soluble polymer. Examples of the binder types include gelatin, carrageenan, polyvinyl alcohol (PVA), polyvinyl pyrrolidone (PVP), polysaccharides such as starch, cellulose and the derivatives thereof, polyethylene oxide, polyvinylamine, chitosan, polylysine, polyacrylic acid, polyalginic acid, polyhyaluronic acid, carboxy cellulose, gum arabic, sodium alginate, and the like. Among these, gelatin is preferable for the reason that the adhesiveness of the conductive thin wires 34 and the substrate 22 is better.

Here, other than lime-treated gelatin, acid-treated gelatin may be used as the gelatin and it is possible to use a hydrolysate of gelatin, a gelatin enzyme decomposed product, and other gelatins in which an amino group and a carboxyl group are modified (phthalated gelatin and acetylated gelatin).

In addition, a polymer (also simply referred to below as a polymer) which is different from the gelatin described above may be used with gelatin as a binder.

The type of the polymer to use is not particularly limited as long as the polymer is different from gelatin; however, examples thereof include at least any resin selected from the group consisting of an acryl-based resin, a styrene-based resin, a vinyl-based resin, a polyolefin-based resin, a polyester-based resin, a polyurethane-based resin, a polyamide-based resin, a polycarbonate-based resin, a polydiene-based resin, an epoxy-based resin, a silicone-based resin, a cellulose-based polymer, and a chitosan-based polymer or a copolymer which is formed by the monomers which form these resins or the like.

The volume ratio (volume of metal/volume of binder) of the metal to the binder in the conductive thin wires 34 is preferably 1.0 or more and more preferably 1.5 or more. Setting the volume ratio of metal to a binder to 1.0 or more makes it possible to further increase the conductivity of the conductive thin wires 34. The upper limit is not particularly limited: however, from the point of view of productivity, 6.0 or less is preferable, 4.0 or less is more preferable, and 2.5 or less is even more preferable.

Here, it is possible to calculate the volume ratio of the metal to the binder according to the density of the metal and the binder which are included in the conductive thin wires 34. For example, the volume ratio is obtained by calculating after setting the density of silver to be 10.5 g/cm³ in a case where the metal is silver and setting the density of gelatin to be 1.34 g/cm³ in a case where the binder is gelatin.

The line width of the conductive thin wires 34 is not particularly limited; however, from the point of view that it is possible to comparatively easily form low resistant electrodes, 30 μm or less is preferable, 15 μm or less is more preferable, 10 μm or less is even more preferable, 9 μm or less is particularly preferable, 7 μm or less is most preferable, 0.5 μm or more is preferable, and 1.0 μm or more is more preferable.

The thickness of the conductive thin wires 34 is not particularly limited; however, from the point of view of the conductivity and visibility, it is possible to select from 0.00001 mm to 0.2 mm; however, 30 μm or less is preferable, 20 μm or less is more preferable, 0.01 μm to 9 μm is even more preferable, and 0.05 μm to 5 μm is most preferable.

The grids 36 include an opening region which is surrounded by the conductive thin wires 34. A length W of one side of the grid 36 is preferably 800 μm or less, more preferably 600 μm or less, even more preferably 400 μm or less, preferably 5 μm or more, more preferably 30 μm or more, and even more preferably 80 μm or more.

In the first detection electrodes 24 and the second detection electrodes 28, in terms of the visible light transmittance, the opening ratio is preferably 85% or more, more preferably 90% or more, and most preferably 95% or more. The opening ratio is equivalent to a ratio entirely taken up by the transmitted portion apart from the conductive thin wires 34 in the first detection electrodes 24 or the second detection electrodes 28 in a predetermined region.

The grid 36 has a substantially rhomboid shape. However, the shape may be polygonal (for example, triangular, quadrangular, hexagonal, or a random polygon) other than this. In addition, the shape of one side may be a curve or an arc other than a straight line. In a case of an arc, for example, two sides which are opposed to each other may be convex arcs to the outside and the other two sides which are opposed to each other may be convex arcs to the inside. In addition, the shape of each side may be a wavy line where a convex arc to the outside and a convex arc to the inside are continuous. Naturally, the shape of each side may be a sine curve.

Here, the conductive thin wires 34 are formed as a mesh pattern in FIG. 8; however, the present invention is not limited to this aspect and may be a stripe pattern.

The first lead-out wiring 26 and the second lead-out wiring 30 are members which fulfil a role of applying a voltage to the first detection electrodes 24 and the second detection electrodes 28 respectively.

The first lead-out wiring 26 is arranged on the substrate 22 in the outside region E_{O}, one end thereof is electrically connected with the corresponding first detection electrode 24, and the other end is electrically connected with the flexible printed wiring board 32.

The second lead-out wiring 30 is arranged on the substrate 22 in the outside region E_{O}, one end thereof is electrically connected with the corresponding second detection electrode 28, and the other end is electrically connected with the flexible printed wiring board 32.

Here, 5 of the first lead-out wiring 26 and 5 of the second lead-out wiring 30 are illustrated in FIG. 6; however, the number is not particularly limited and a plurality thereof are generally arranged according to the number of the detection electrodes.

Examples of the material which forms the first lead-out wiring 26 and the second lead-out wiring 30 include metal such as gold (Au), silver (Ag), and copper (Cu), metal oxides such as tin oxide, zinc oxide, cadmium oxide, gallium oxide, and titanium oxide, and the like. Among these, silver is preferable for the reason that the conductivity is excellent. In addition, the first lead-out wiring 26 and the second lead-out wiring 30 may be formed of metal paste such as silver paste or copper paste or a metal or alloy thin film such as aluminum (Al) or molybdenum (Mo). A screen printing or ink jet printing method is favorably used in the case of metal paste and a patterning method such as a photolithography method of a sputtering film is favorably used in the case of a metal or alloy thin film.

Here, in terms of the adhesiveness with the substrate 22 being better, a binder is preferably included in the first lead-out wiring 26 and the second lead-out wiring 30. The binder type is as described above.

The flexible printed wiring board 32 is a board where a plurality of wires and terminals are provided on a substrate and is connected with each of the other ends of the first lead-out wiring 26 and each of the other ends of the second lead-out wiring, 30 and fulfills a role of connecting the capacitance touch panel sensor 180 and an external apparatus (for example, a display apparatus).

(Method for Manufacturing Capacitance Touch Panel Sensor)

The method for manufacturing the capacitance touch panel sensor 180 is not particularly limited and it is possible to adopt methods which are known in the art. Examples thereof include a method for exposing a photoresist film on a metal foil which is formed on both main surfaces of the substrate 22, carrying out a developing process, forming a resist pattern, and etching the metal foil which is exposed from the resist pattern. In addition, examples thereof include a method for printing a paste which includes metal fine particles or metal nanowire on both main surfaces of the substrate 22 and carrying out metal plating on the paste. In addition, examples thereof also include a method of printing and forming on the substrate 22 using a screen printing plate or gravure printing plate or an ink jet forming method.

Furthermore, examples thereof include a method using halogenated silver other than the methods described above. In more detail, examples thereof include a method which includes a step (1) of forming a halogenated silver emulsion layer (also simply referred to below as a photosensitive layer) which contains halogenated silver and a binder on each of both surfaces of the substrate 22 and a step (2) of carrying out a developing process after exposing the photosensitive layer.

Description will be given below of each of the steps.

[Step (1): Photosensitive Layer Forming Step]

Step (1) is a step of forming a photosensitive layer which contains halogenated silver and a binder on both surfaces of the substrate 22.

The method for forming the photosensitive layer is not particularly limited; however, in terms of productivity, a method for bringing a composition for forming a photosensitive layer which contains halogenated silver and a binder into contact with the substrate 22 and forming a photosensitive layer on both surfaces of the substrate 22 is preferable.

After detailed description is given of an aspect of the composition for forming a photosensitive layer which is used in the method described above, detailed description will be given below of the procedure of the steps.

The composition for forming a photosensitive layer contains halogenated silver and a binder.

The halogen element which is contained in the halogenated silver may be any of chlorine, bromine, iodine, and fluorine and may be a combination thereof. For example, halogenated silver which has silver chloride, silver bromide, and silver iodide as the main body is preferably used as the halogenated silver and halogenated silver which has silver bromide and silver chloride as the main body is more preferably used.

The binder type to be used is as described above. In addition, the composition for forming a photosensitive layer may include a binder in latex form.

The volume ratio of the halogenated silver to the binder included in the composition for forming a photosensitive layer is not particularly limited and is appropriately adjusted so as to be in the favorable volume ratio range of the metal and the binder in the conductive thin wires 34 described above.

The composition for forming a photosensitive layer contains a solvent as necessary.

Examples of the solvents to be used include water, organic solvents (for example, alcohols such as methanol, ketones such as acetone, amides such as formamide, sulfoxides such as dimethyl sulfoxide, esters such as ethyl acetate, ethers, and the like), ionic liquids, or mixed solvents thereof.

The content of the solvent to be used is not particularly limited, but is preferably in a range of 30 mass % to 90 mass % with respect to the total mass of the halogenated silver and the binder, and more preferably 50 mass % to 80 mass %.

(Procedure of Steps)

The method for bringing the composition for forming a photosensitive layer and the substrate 22 into contact is not particularly limited and it is possible to adopt methods which are known in the art. Examples thereof include a method for coating the composition for forming a photosensitive layer on the substrate 22, a method for immersing the substrate 22 in the composition for forming a photosensitive layer, and the like.

The content of the binder in the formed photosensitive layer is not particularly limited, but is preferably 0.3 g/m² to 5.0 g/m², and more preferably 0.5 g/m² to 2.0 g/m².

In addition, the content of the halogenated silver in the photosensitive layer is not particularly limited; however, in terms of the conductivity of the conductive thin wires 34 being better, 1.0 g/m² to 20.0 g/m² in silver conversion is preferable, and 5.0 g/m² to 15.0 g/m² is more preferable.

Here, a protective layer formed by a binder may be further provided on the photosensitive layer as necessary. Providing a protective layer prevents scratches or improves the mechanical characteristics.

[Step (2): Exposing and Developing Step]

Step (2) is a step of forming the first detection electrodes 24 and the first lead-out wiring 26 and the second detection electrodes 28 and the second lead-out wiring 30 by carrying out a developing process after pattern exposing the photosensitive layer which is obtained in step (1) described above.

Detailed description will be firstly given below of the pattern exposing process and then detailed description will be given of the developing process.

(Pattern Exposing)

Carrying out exposure in the form of a pattern with respect to the photosensitive layer makes the halogenated silver in the photosensitive layer form a latent image in the exposure region. Conductive thin wires are formed by a developing process which will be described below in the region in which the latent image is formed. On the other hand, in a non-exposure region in which exposure is not carried out, halogenated silver melts and flows away from the photosensitive layer during a fixing process which will be described below and a transparent film is obtained.

The light source which is used during the exposure is not particularly limited and examples thereof include light such as visible rays and ultraviolet rays, radiation such as X rays, and the like.

The method for performing the pattern exposure is not particularly limited and, for example, the pattern exposure may be performed by surface exposure which uses a photo mask or may be performed by scanning exposure using a laser beam. Here, the shape of the pattern is not particularly limited and is appropriately adjusted according to the pattern of the conductive thin wires to be formed.

(Developing Process)

The method for developing process is not particularly limited and it is possible to adopt methods which are known in the art. For example, it is possible to use general developing process techniques which are used for silver salt photograph films, printing paper, printing plate films, emulsion masks for photo masks, and the like.

The type of a developing solution which is used during the developing process is not particularly limited; however, for example, it is also possible to use a PQ developing solution, an MQ developing solution, an MAA developing solution, and the like. In commercially available products, for example, it is possible to use a developing solution such as CN-16, CR-56, CP45X, FD-3, and PAPITOL formulated by Fujifilm Corporation and C-41, E-6, RA-4, D-19, and D-72 formulated by Kodak Japan Ltd., or a developing solution which is included in a kit thereof. In addition, it is also possible to use a lithographic developing solution.

It is possible to include a fixing process which is performed for the purpose of removing silver salt in the non-exposure portion and stabilization in the developing process. It is possible for the fixing process to use fixing process techniques which are used for silver salt photograph films, printing paper, printing plate films, emulsion masks for photo masks, and the like.

The fixing temperature in the fixing step is preferably approximately 20° C. to approximately 50° C., and more preferably 25° C. to 45° C. In addition, the fixing time is preferably 5 seconds to 1 minute and more preferably 7 seconds to 50 seconds.

The mass of metal silver which is included in the exposure section (the conductive thin wire) after the developing process preferably has a content ratio of 50 mass % or more with respect to the mass of silver which is included in the exposure section before exposure, and more preferably 80 mass % or more. When the mass of silver which is included in the exposure section is 50 mass % or more with respect to the mass of silver which is included in the exposure section before exposure, it is possible to obtain high conductivity, which is preferable.

Other than the steps described above, the following undercoat layer forming step, antihalation layer forming step, or heating process may be carried out as necessary.

(Undercoat Layer Forming Step)

For the reason of having excellent adhesiveness between the substrate 22 and the halogenated silver emulsion layer, a step of forming an undercoat layer which includes the binder described above on both surfaces of the substrate 22 is preferably carried out before step (1) described above.

The binder to be used is as described above. The thickness of the undercoat layer is not particularly limited; however, in terms of being able to further suppress the adhesiveness and the rate of change in the mutual capacitance, 0.01 μm to 0.5 μm is preferable, and 0.01 μm to 0.1 μm is more preferable.

(Antihalation Layer Forming Step) From the point of view of thinning the conductive thin wires 34, a step of forming an antihalation layer on both surfaces of the substrate 22 is preferably carried out before step (1) described above.

(Step (3): Heating Step)

Step (3) is a step of carrying out a heating process after the developing process described above and may be carried out as necessary. By carrying out the present step, fusion welding occurs between the binders and the hardness of the conductive thin wires 34 is increased further. In particular, in a case of dispersing polymer particles in a composition for forming a photosensitive layer as a binder (in a case where the binder is polymer particles in latex), by carrying out the present step, fusion welding occurs between the polymer particles and the conductive thin wires 34 which exhibit the desired hardness are formed.

Favorable conditions are appropriately selected for the conditions of the heating process according to the binder to be used; however, from the point of view of the film-forming temperature of polymer particles, 40° C. or more is preferable, 50° C. or more is more preferable, and 60° C. or more is even more preferable. In addition, from the point of view of suppressing curling and the like in the substrate, 150° C. or less is preferable, and 100° C. or less is more preferable.

The heating time is not particularly limited; however, from the point of view of suppressing curling and the like in the substrate and the point of view of productivity, 1 minute to 5 minutes is preferable, and 1 minute to 3 minutes is more preferable.

Here, since it is possible to carry out the heating process along with a drying step which is generally performed after the exposing and developing process, it is not necessary to add a new step for film-forming the polymer particles, which is excellent from the point of view of productivity, cost, and the like.

Here, by carrying out the step described above, a light transmitting section which includes a binder is formed between the conductive thin wires 34. Regarding the transmittance in the light transmitting section, the transmittance which is indicated by the minimum value of the transmittance in the wavelength region of 380 nm to 780 nm is preferably 90% or more, more preferably 95% or more, even more preferably 97% or more, particularly preferably 98% or more, and most preferably 99% or more.

The light transmitting section may include material other than the binder described above and examples thereof include a sparingly-soluble silver agent and the like.

The aspects of the capacitance touch panel sensor are not limited to the aspect in FIG. 6 described above and there may be other aspects.

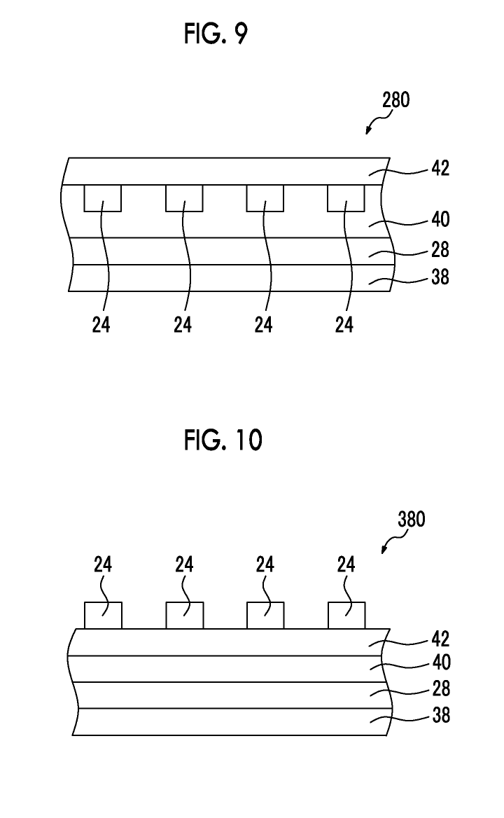

For example, as shown in FIG. 9, a capacitance touch panel sensor 280 comprises a first substrate 38, second detection electrodes 28 which are arranged on the first substrate 38, second lead-out wiring (which is not shown in the diagram) which is electrically connected with one end of the second detection electrode 28 and which is arranged on the first substrate 38, an adhesive layer 40, first detection electrodes 24, first lead-out wiring (which is not shown in the diagram) which are electrically connected with one end of the first detection electrodes 24, a second substrate 42 which is adjacent to the first detection electrodes 24 and the first lead-out wires, and a flexible printed wiring board (which is not shown in the diagram).

As shown in FIG. 9, since the capacitance touch panel sensor 280 has the same configuration as the capacitance touch panel sensor 180 except for the first substrate 38, the second substrate 42, and the adhesive layer 40, the same reference numerals are given to the same constituent elements and description thereof will be omitted.

The definitions of the first substrate 38 and the second substrate 42 are the same as the definition of the substrate 22 described above.

The adhesive layer 40 is a layer for closely attaching the first detection electrode 24 and the second detection electrodes 28 and is preferably optically transparent (preferably a transparent adhesive layer). Materials which are known in the art are used for the materials which form the adhesive layer 40 and the adhesive layer 12 described above may be used as the adhesive layer 40.

A plurality of the first detection electrodes 24 and a plurality of the second detection electrodes 28 in FIG. 9 are each used as shown in FIG. 6 and are arranged such that both are orthogonal to each other as shown in FIG. 6.

Here, the capacitance touch panel sensor 280 shown in FIG. 9 corresponds to a capacitance touch panel sensor which is obtained by preparing two electrode-attached substrates, each of which has a substrate and detection electrodes and lead-out wires which are arranged on the substrate surface and adhering the substrates via an adhesive layer such that the electrodes are faced with each other.

Examples of another aspect of the capacitance touch panel sensor include the aspect shown in FIG. 10.

A capacitance touch panel sensor 380 comprises the first substrate 38, second detection electrodes 28 which are arranged on the first substrate 38, second lead-out wiring (which is not shown in the diagram) which is electrically connected with one end of the second detection electrode 28 and which is arranged on the first substrate 38, the adhesive layer 40, the second substrate 42, first detection electrodes 24 which are arranged on the second substrate 42, first lead-out wiring (which is not shown in the diagram) which is electrically connected with one end of the first detection electrode 24 and which is arranged on the second substrate 42, and a flexible printed wiring board (which is not shown in the diagram).

Since the capacitance touch panel sensor 380 shown in FIG. 10 has the same layers as the capacitance touch panel sensor 280 shown in FIG. 9 except that the order of each layer is different, the same reference numerals are given to the same constituent elements and description thereof will be omitted.

In addition, a plurality of the first detection electrodes 24 and a plurality of the second detection electrodes 28 in FIG. 10 are each used as shown in FIG. 6 and are arranged such that both are orthogonal to each other as shown in FIG. 6.

Here, the capacitance touch panel sensor 380 shown in FIG. 10 corresponds to a capacitance touch panel sensor which is obtained by preparing two electrode-attached substrates, each of which has a substrate and detection electrodes and lead-out wires which are arranged on the substrate surfaces and adhering the substrates via an adhesive layer such that one substrate in the electrode-attached substrates and the electrodes of the other electrode-attached substrate face each other.

As another aspect of the capacitance touch panel sensor, for example, in FIG. 6, the conductive thin wires 34 of the first detection electrodes 24 and the second detection electrodes 28 may be formed by metal oxide particles and metal paste such as silver paste and copper paste. Among these, in terms of having excellent conductivity and transparency, a conductive film and a silver nanowire conductive film using silver thin wires are preferable.

In addition, the first detection electrodes 24 and the second detection electrodes 28 are formed by a mesh structure of the conductive thin wires 34; however, without being limited to this aspect, for example, the first detection electrodes 24 and the second detection electrodes 28 may be formed by a metal oxide thin film (a transparent metal oxide thin film) such as ITO and ZnO and a transparent conductive film which forms a network using metal nanowire such as silver nanowire and copper nanowire.

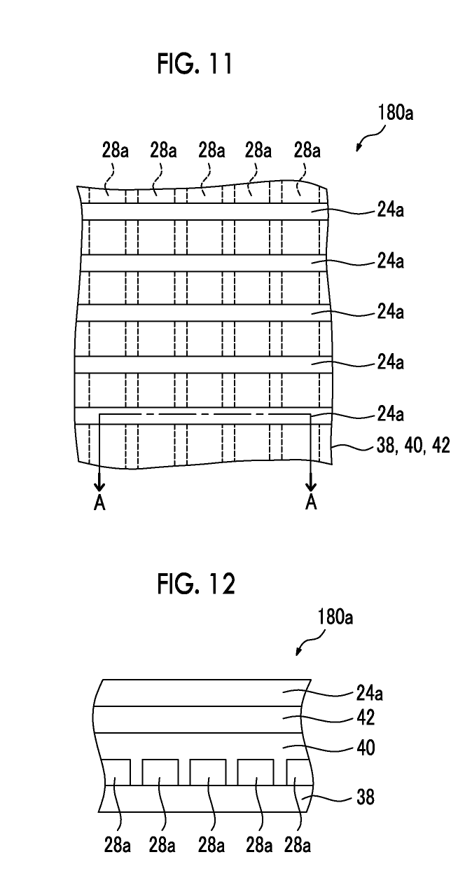

In more detail, as shown in FIG. 11, the aspect may be a capacitance touch panel sensor 180a which has first detection electrodes 24a and second detection electrodes 28a which are formed of a transparent metal oxide. FIG. 11 shows a partial planar diagram in an input region of the capacitance touch panel sensor 180a. FIG. 12 is a cross-sectional diagram which cuts FIG. 11 along the cut line A-A. The capacitance touch panel sensor 180a comprises the first substrate 38, second detection electrodes 28a which are arranged on the first substrate 38, second lead-out wiring (which is not shown in the diagram) which is electrically connected with one end of the second detection electrode 28a and which is arranged on the first substrate 38, the adhesive layer 40, the second substrate 42, first detection electrodes 24a which are arranged on the second substrate 42, a first lead-out wire (which is not shown in the diagram) which is electrically connected with one end of the first detection electrodes 24a and which is arranged on the second substrate 42, and a flexible printed wiring board (which is not shown in the diagram).

Since the capacitance touch panel sensor 180a shown in FIG. 11 and FIG. 12 has the same layers as the capacitance touch panel sensor 380 shown in FIG. 10 except for the first detection electrodes 24a and the second detection electrodes 28a, the same reference numerals are given to the same constituent elements and description thereof will be omitted.

The capacitance touch panel sensor 180a shown in FIG. 11 and FIG. 12 corresponds to a capacitance touch panel sensor which is obtained by preparing two electrode-attached substrates, each of which has a substrate and detection electrodes and lead-out wires which are arranged on the substrate surface and adhering the substrates via an adhesive layer such that one substrate in the electrode-attached substrates and the electrodes of the other electrode-attached substrate face each other.

The first detection electrodes 24a and the second detection electrodes 28a are electrodes which extend in the X axis direction and the Y axis direction respectively and are formed of a transparent metal oxide, for example, formed of indium tin oxide (ITO). Here, in FIG. 11 and FIG. 12, in order to utilize transparent electrodes ITO as a sensor, the level of the resistance of the indium tin oxide (ITO) itself is designed to further reduce the thickness, utilize the characteristics of the transparent electrodes, and secure the light transmittance by increasing the electrode area to reduce the total wiring resistance.

Here, examples of materials which are able to be used in the aspect described above other than ITO include zinc oxide (ZnO), indium zinc oxide (IZO), gallium zinc oxide (GZO), aluminum zinc oxide (AZO), and the like.

Here, it is possible to select the patterning of the electrode section (the first detection electrodes 24a and the second detection electrodes 28a) according to the material of the electrode section, and a photolithography method, a resist mask screen printing-etching method, an ink jet method, a printing method, and the like may be used.

(Protective Substrate)

The protective substrate 16 is a substrate which is arranged on an adhesive layer and fulfills a role of protecting a capacitance touch panel 14 which will be described below from the external environment, and the main surface thereof forms a touch surface.

The protective substrate 16 is preferably a transparent substrate and a plastic film, a plastic board, a glass board, and the like are able to be used. The thickness of the substrate is desirably appropriately selected according to each application.

As the raw material of the plastic film and the plastic board described above, for example, it is possible to use polyesters such as polyethylene terephthalate (PET) and polyethylene naphthalate (PEN); polyolefins such as polyethylene (PE), polypropylene (PP), polystyrene, and EVA; vinyl-based resins; other than these, polycarbonate (PC), polyamide, polyimide, an acryl resin, triacetyl cellulose (TAC), a cycloolefin-based resin (COP), and the like.

In addition, a polarizing plate, a circularly polarizing plate, and the like may be used as the protective substrate 16.

(Display Apparatus)

The display apparatus 18 is an apparatus which has a display surface which displays mage and each member is arranged on the display screen side.

The type of the display apparatus 18 is not particularly limited and it is possible to use display apparatuses which are known in the art. Examples thereof include a cathode ray tube (CRT) display apparatus, a liquid crystal display device (LCD), an organic light emitting diode (OLED) display apparatus, a vacuum fluorescent display (VFD), a plasma display panel (PDP), a surface electric display (SED), a field emission display (FED), electronic paper (E-Paper), and the like.

### EXAMPLES

Detailed description will be given below of the present invention using Examples; however, the present invention is not limited thereto.

### Synthesis Example 1

A coating liquid P-1 (a composition for forming an adhesive layer) with a viscosity of 5000 mPa·s to 8000 mPa·s was obtained by adding a coating liquid raw material to a reactor vessel and evenly stirring such that 2-ethylhexyl acrylate (produced by Mitsubishi Chemical Corporation) was 46 parts by mass, dodecyl acrylate (produced by Kyoeisha Chemical Co., Ltd.) was 13 parts by mass, isobornyl acrylate (produced by Kyoeisha Chemical Co., Ltd.) was 38 parts by mass, 1-hydroxy cyclohexyl phenyl ketone (produced by BASF Corporation) was 2.3 parts by mass, and (2,4,6-trimethyl benzoyl)diphenyl phosphine oxide (produced by BASF Corporation) was 0.7 parts by mass and polymerizing the resultant while irradiating the resultant with UV light using light from a high pressure mercury UV lamp (DEEP UV lamp UXM-501MD, manufactured by Ushio Inc.).

After coating the obtained coating liquid P-1 on a release surface of a release polyethylene terephthalate (PET) film, an adhesive film S-01 where an adhesive layer is interposed between release PET films was obtained by further adhering a release PET film of which the release surface faced downward on the coating film surface, forming the thickness after curing to be 50 μm, and further irradiating the result with UV light such that the irradiation energy was 2 J/cm².

### Synthesis Example 2

An adhesive film S-02 was obtained according to the same steps as in Synthesis Example 1 apart from changing the coating liquid raw material of Synthesis Example 1 such that 2-ethylhexyl acrylate was 48 parts by mass, dodecyl acrylate was 14 parts by mass, isobornyl acrylate was 27 parts by mass, benzyl acrylate (produced by Hitachi Chemical Co., Ltd.) was 8 parts by mass, 1-hydroxy cyclohexyl phenyl ketone was 2.3 parts by mass, and (2,4,6-trimethyl benzoyl)diphenyl phosphine oxide was 0.7 parts by mass.

### Synthesis Example 3

An adhesive film S-03 was obtained according to the same steps as in Synthesis Example 1 apart from changing the coating liquid raw material of Synthesis Example 1 such that 2-ethylhexyl acrylate was 35 parts by mass, dodecyl acrylate was 9 parts by mass, isobornyl acrylate was 35 parts by mass, stearyl acrylate (produced by Kyoeisha Chemical Co., Ltd.) was 18 parts by mass, 1-hydroxy cyclohexyl phenyl ketone was 2.3 parts by mass, and (2,4,6-trimethyl benzoyl)diphenyl phosphine oxide was 0.7 parts by mass.

### Synthesis Example 4

An adhesive film S-04 was obtained according to the same steps as in Synthesis Example 1 apart from changing the coating liquid raw material of Synthesis Example 1 such that 2-ethylhexyl acrylate was 26 parts by mass, dodecyl acrylate was 25 parts by mass, isobornyl acrylate was 36 parts by mass, stearyl acrylate was 10 parts by mass, 1-hydroxy cyclohexyl phenyl ketone was 2.3 parts by mass, and (2,4,6-trimethyl benzoyl)diphenyl phosphine oxide was 0.7 parts by mass.

### Synthesis Example 5

An adhesive film S-05 was obtained according to the same steps as in Synthesis Example 1 apart from changing the coating liquid raw material of Synthesis Example 1 such that 2-ethylhexyl acrylate was 45 parts by mass, dodecyl acrylate was 14 parts by mass, isobornyl acrylate was 19 parts by mass, dicyclopentanyl acrylate (produced by Hitachi Chemical Co., Ltd.) was 19 parts by mass, 1-hydroxy cyclohexyl phenyl ketone was 2.3 parts by mass, and (2,4,6-trimethyl benzoyl)diphenyl phosphine oxide was 0.7 parts by mass.

### Synthesis Example 6

An adhesive film S-06 was obtained according to the same steps as in Synthesis Example 1 apart from changing the coating liquid raw material of Synthesis Example 1 such that 2-ethylhexyl acrylate was 45 parts by mass, dodecyl acrylate was 13 parts by mass, isobornyl acrylate was 17 parts by mass, isobornyl methacrylate (produced by Kyoeisha Chemical Co., Ltd.) was 3 parts by mass, dicyclopentanyl acrylate was 19 parts by mass, 1-hydroxy cyclohexyl phenyl ketone was 2.3 parts by mass, and (2,4,6-trimethyl benzoyl)diphenyl phosphine oxide was 0.7 parts by mass.

### Synthesis Example 7

An adhesive film S-07 was obtained according to the same steps as in Synthesis Example 1 apart from changing the coating liquid raw material of Synthesis Example 1 such that 2-ethylhexyl acrylate was 45 parts by mass, dodecyl acrylate was 13 parts by mass, isobornyl acrylate was 19 parts by mass, dicyclopentanyl acrylate was 14 parts by mass, 2-methyl-2-adamantyl methacrylate was 6 parts by mass, 1-hydroxy cyclohexyl phenyl ketone was 2.3 parts by mass, and (2,4,6-trimethyl benzoyl)diphenyl phosphine oxide was 0.7 parts by mass.

### Synthesis Example 8

An adhesive film S-08 was obtained according to the same steps as in Synthesis Example 1 apart from changing the coating liquid raw material of Synthesis Example 1 such that 2-ethylhexyl acrylate was 43 parts by mass, dodecyl acrylate was 15 parts by mass, stearyl acrylate was 5 parts by mass, isobornyl acrylate was 6 parts by mass, isobornyl methacrylate was 15 parts by mass, dicyclopentanyl acrylate was 6 parts by mass, 2-methyl-2-adamantyl methacrylate was 7 parts by mass, 1-hydroxy cyclohexyl phenyl ketone was 2.3 parts by mass, and (2,4,6-trimethyl benzoyl)diphenyl phosphine oxide was 0.7 parts by mass.

### Synthesis Example 9

An adhesive film S-11 was obtained according to the same steps as in Synthesis Example 1 apart from changing the coating liquid raw material of Synthesis Example 1 such that 2-ethylhexyl acrylate was 47 parts by mass, dodecyl acrylate was 9 parts by mass, isobornyl acrylate was 42 parts by mass, and 1-hydroxy cyclohexyl phenyl ketone was 2.0 parts by mass.

### Synthesis Example 10

A coating liquid P-12 was obtained according to the same steps as in Example 1 apart from changing the coating liquid raw material of Synthesis Example 1 such that 2-ethylhexyl acrylate was 88 parts by mass, dodecyl acrylate was 1 part by mass, and 1-hydroxy cyclohexyl phenyl ketone was 2.0 parts by mass.

An adhesive film S-12 was obtained according to the same steps as Synthesis Example 1 apart from mixing triaryl isocyanurate (9 parts by mass) in the obtained coating liquid P-12 and then using this mixture instead of the coating liquid P-1.

### Synthesis Example 11

An adhesive film S-13 was obtained according to the same steps as in Synthesis Example 1 apart from changing the coating liquid raw material of Synthesis Example 1 such that 2-ethylhexyl acrylate was 52 parts by mass, isobornyl methacrylate is 30 parts by mass, 2-hydroxyethyl acrylate (produced by Kyoeisha Chemical Co., Ltd.) was 16 parts by mass, and 1-hydroxy cyclohexyl phenyl ketone was 2.0 parts by mass.

### Synthesis Example 12

An adhesive film S-14 was obtained according to the same steps as in Synthesis Example 1 apart from changing the coating liquid raw material of Synthesis Example 1 such that 2-ethylhexyl acrylate was 50 parts by mass, dodecyl acrylate was 10 parts by mass, isobornyl acrylate was 25 parts by mass, benzyl acrylate was 3 parts by mass, acryloyl morpholine (produced by Tokyo Chemical Industry Co., Ltd.) was 9 parts by mass, 1-hydroxy cyclohexyl phenyl ketone was 2.3 parts by mass, and (2,4,6-trimethyl benzoyl)diphenyl phosphine oxide was 0.7 parts by mass.

### Synthesis Example 13

8 parts by mass of hydrogenated terpene acrylate (produced by Yasuhara Chemical Co., Ltd.) which is described in Chemical Formula 1 below, 31.6 parts by mass of isodecyl acrylate, and 0.4 parts by mass of light acrylate HOB-A (produced by Kyoeisha Chemical Co., Ltd.) were mixed in 60 parts by mass of ethyl acetate, 0.1 parts by mass of 2,2′-isobutyro acrylonitrile (produced by Wako Pure Chemical Industries, Ltd.) were added thereto, nitrogen gas was introduced while stirring, and the gas was replaced.

A polymer solution P-15 was obtained by stirring for 12 hours while keeping, the temperature in the reaction liquid 60° C.

A coating liquid C-15 was obtained by adding 1 part by mass of D110N (produced by Mitsui Chemicals. Inc., 75% ethyl acetate solution) and 0.1 parts by mass of KBM-403 (produced by Shin-Etsu Chemical Co., Ltd.) with respect to a solid content of 100 parts by mass in the obtained polymer solution P-15 to the polymer solution.

After coating a release surface of the release PET with the obtained coating liquid C-15, an adhesive film S-15 was obtained by heating a coated sample at 120° C. for 3 minutes, curing the adhesive layer, and further adhering the release surface of the release PET to the exposed surface of the adhesive layer.

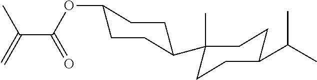 [SMILES: C=C(C)C(=O)OC1CCC(C2(C)CCC(C(C)C)CC2)CC1]

### Synthesis Example 14

An adhesive film S-16 was obtained according to the same steps as in Synthesis Example 13 apart from using cyclohexyl acrylate (produced by Kyoeisha Chemical Co., Ltd.) instead of the hydrogenated terpene acrylate of Synthesis Example 13.

### Synthesis Example 15

A coating liquid P-17 was obtained in the same manner as in Synthesis Example 13 using 45 parts by mass of 2-ethylhexyl acrylate, 8 parts by mass of dodecyl acrylate, 42 parts by mass of isobornyl acrylate instead of acrylates which are used in the coating raw material of Synthesis Example 13, and using 4 parts by mass (3 parts by mass of solid content) of D140N (produced by Mitsui Chemicals Inc., 75% ethyl acetate solution) instead of D110N, such that the 1-hydroxy cyclohexyl phenyl ketone was 2.0 parts by mass as the initiator.

An adhesive film S-17 was obtained in the same manner as in Synthesis Example 13 apart from using the obtained coating liquid P-17.

### Examples 1 to 9 and Comparative Examples 1 to 8

### <A> Method for Manufacturing Silver Mesh Wire

(Preparing Halogenated Silver Emulsion)

0.16 μm nuclear particles were formed by adding amounts corresponding to 90% of each of the liquid 2 and liquid 3 described below to the liquid 1 described below which was kept at 38° C. and pH 4.5 at the same time over 20 minutes while stirring. Subsequently, the particles were grown to 0.21 μm by adding the liquid 4 and liquid 5 described below over 8 minutes and further adding an amount of the remaining 10% of the liquid 2 and liquid 3 described below over 2 minutes. Furthermore, the particle forming was completed by adding 0.15 g of potassium iodide and aging the resultant for 5 minutes.

| Liquid 1: | | |
|---|---|---|
| Water | 750 | ml |
| Gelatin | 9 | g |
| Sodium chloride | 3 | g |
| 1,3-dimethylimidazolidine-2-thione | 20 | mg |
| Sodium benzene thiosulfonate | 10 | mg |
| Citric acid | 0.7 | g |
| Liquid 2: | | |
| Water | 300 | ml |
| Silver nitrate | 150 | g |
| Liquid 3: | | |
| Water | 300 | ml |
| Sodium chloride | 38 | g |
| Potassium bromide | 32 | g |
| Potassium hexachloroiridate (III) | 8 | ml |
| (0.005% KCI 20% aqueous solution) | | |
| Ammonium hexachlororhodate | 10 | ml |
| (0.001% NaCl 20% water solution) | | |
| Liquid 4: | | |
| Water | 100 | ml |
| Silver nitrate | 50 | g |
| Liquid 5: | | |
| Water | 100 | ml |
| Sodium chloride | 13 | g |
| Potassium bromide | 11 | g |
| Potassium ferrocyanide | 5 | mg |

After that, water cleansing was carried out by a flocculation method following a typical method. In detail, the temperature was decreased to 35° C. and the pH was decreased using sulfuric acid (the pH was in a range of 3.6±0.2) until the halogenated silver was precipitated. Next, approximately 3 liters of a supernatant liquid were removed (first water cleansing). After further adding 3 liters of distilled water, sulfuric acid was added until the halogenated silver was precipitated. 3 liters of a supernatant liquid were removed again (second water cleansing). The same operation as in the second water cleansing was repeated one more time (third water cleansing) and the water cleansing and salt removal step was completed. The emulsion after water cleansing and salt removal was adjusted to pH 6.4 and pAg 7.5, 3.9 g of gelatin, 10 mg of sodium benzene thiosulfonate, 3 mg of sodium benzene thiosulfinate, 15 mg of sodium thiosulfate, and 10 mg of chloroauric acid were added, chemosensitization was carried out so as to obtain an optimum sensitivity at 55° C., and 100 mg of 1,3,3a,7-tetraazaindene as a stabilizer and 100 mg of PROXEL (product name, produced by ICI Co., Ltd.) as an anti-septic agent were added. The emulsion which was finally obtained was a silver iodochlorobromide cubic particle emulsion which included 0.08 mol % of silver iodide and where the ratio of silver chlorobromide was 70 mol % of silver chloride and 30 mol % of silver bromide, the average particle diameter was 0.22 μm, and the coefficient of variation was 9%.

(Preparation of Composition for Forming Photosensitive Layer)

A composition for forming a photosensitive layer was obtained by adding 1.2×10⁴ mol/molAg of 1,3,3a,7-tetraazaindene, 1.2×10⁻² mol/molAg of hydroquinone, 3.0×10⁻⁴ mol/molAg of citric acid, and 0.90 g/molAg of 2,4-dichloro-6-hydroxy-1,3,5-triazine sodium salt to the emulsion described above and adjusting the coating liquid pH to 5.6 using citric acid.

(Photosensitive Layer Forming Step)

After carrying out a corona discharge treatment on a polyethylene terephthalate (PET) film with a thickness of 100 μm, a gelatin layer with a thickness of 0.1 μm as an undercoat layer and also an antihalation layer of which the optical density was approximately 1.0 and which included a dye which was decolorized by an alkali developing solution on the undercoat layer were provided on both surfaces of the PET film described above. A PET film where a photosensitive layer was formed on both surfaces was obtained by coating the composition for forming a photosensitive layer on the antihalation layer described above and further providing a gelatin layer with a thickness of 0.15 μm. The obtained film is a film A. The formed photosensitive layer had a silver content of 6.0 g/m² and a gelatin content of 1.0 g/m².

(Exposing and Developing Step)

Exposure was performed using parallel light which used a high pressure mercury lamp as light source via a photo mask on which detection electrodes (the first detection electrodes and the second detection electrodes) and lead-out wires (the first lead-out wires and the second lead-out wires) were arranged as shown in FIG. 6 on both surfaces of the film A described above. After the exposure, the developing was carried out using a developing solution and a developing process was further performed using a fixing liquid (product name: N3X-R for CN16X, produced by Fujifilm Corporation). Furthermore, a capacitance touch panel sensor A comprising detection electrodes and lead-out wires formed by Ag thin wires on both surfaces was obtained by rinsing with pure water and drying.

Here, in the obtained capacitance touch panel sensor A, the detection electrodes are formed by conductive thin wires which intersect in a mesh form. In addition, as described above, the first detection electrodes are electrodes which extend in the X direction and the second detection electrodes are electrodes which extend in the Y direction and each is arranged on a film at a pitch of 4.5 mm to 5 mm.

<Capacitance Touch Panel Sensor with ITO Wires>

A capacitance touch panel sensor B which has detection electrodes which are formed from ITO shown in FIG. 11 was manufactured by a method which is known in the art.

More specifically, the configuration of the capacitance touch panel sensor B which has ITO detection electrodes is a capacitance touch panel sensor where a first electrode-attached substrate, which has the first substrate 38 and the second detection electrodes 28a formed of ITO which are arranged on the first substrate 38, and a second electrode-attached substrate, which has the second substrate 42 and the first detection electrodes 24a formed of ITO which are arranged on the second substrate 42, are adhered via the adhesive layer 40 as shown in FIG. 11 described above. Here, the first detection electrodes and the second detection electrodes are orthogonal to each other. In addition, the first detection electrodes and the second detection electrodes are each connected with lead-out wires.

Next, using the adhesive films which were manufactured in Synthesis Examples 1 to 15, a touch panel including a liquid crystal display device, a lower adhesive layer, a capacitance touch panel sensor, an upper adhesive layer, and a glass substrate in this order was manufactured. Here, the capacitance touch panel sensor A or the capacitance touch panel sensor B manufactured as described above was used as the capacitance touch panel sensor.

As the method for manufacturing a touch panel, one release PET film of the adhesive film described above was released, the upper adhesive layer was produced by adhering the adhesive layer described above to a capacitance touch panel sensor using a 2 kg weighted roller, the other release PET film was then released, and a glass substrate with the same size was adhered on the upper adhesive layer using a 2 kg weighted roller in the same manner. After that, a defoaming treatment was carried out by exposure to an environment of 40° C. and 5 atm for 20 minutes in a high pressure thermostatic chamber.

Next, using the adhesive film which was used for producing the upper adhesive layer and following the same steps as for producing the upper adhesive layer, a lower adhesive layer was arranged between a capacitance touch panel sensor with a structural body where the glass substrate, the upper adhesive layer, and a capacitance touch panel sensor were adhered in this order, and a liquid crystal display device, and both were adhered to each other.

After that, the touch panel which was obtained as described above was exposed to an environment of 40° C. and 5 atm for 20 minutes in a high pressure thermostatic chamber.

Here, as the lower part adhesive layer and the upper adhesive layer in the touch panel described above, the adhesive layers in the adhesive films which were produced in Synthesis Examples 1 to 15 were each used (refer to Table 1).

(Producing Samples for Temperature Dependency Evaluation Test)

One release PET film of the adhesive film (here, the thickness of the adhesive layer is 100 μm to 500 μm) which was produced in Synthesis Examples 1 to 15 was released and the exposed surface was adhered to an aluminum (Al) substrate with a length of 20 mm×width of 20 mm and a thickness of 0.5 mm, after which the other release PET film was released and the Al substrate described above was adhered to the exposed surface, then, a pressurized defoaming treatment was carried out at 40° C. at 5 atm for 60 minutes to produce samples for a temperature dependency evaluation test.

Here, regarding the thickness of the adhesive layer in each sample, the thickness at 5 places in a sample for a temperature dependency evaluation test was measured using a micrometer, a thickness equivalent to two of the Al substrates was subtracted from the average value thereof, and the thickness of the adhesive layer was calculated.

(Method for Temperature Dependency Evaluation Test)

Using the samples for the temperature dependency evaluation test which were produced above, impedance measurement at 1 MHz was performed using an impedance analyzer (4294A manufactured by Agilent Technologies Inc.) and the relative permittivity of the adhesive layer was measured.

In detail, the temperature of the sample for a temperature dependency evaluation test was increased by 20° C. from 40° C. to 80° C. in stages and the capacitance C was obtained by impedance measurement at 1 MHz using an impedance analyzer (4294A manufactured by Agilent Technologies Inc.) at each temperature. Here, the sample was left for 5 minutes at each temperature until the temperature of the sample was constant.

After that, using the obtained capacitance C, the relative permittivity at each temperature was calculated by Equation (X) below.

relative permittivity=(capacitance C×thickness T)/(area S×vacuum permittivity ε₀) Equation (X):

Here, the thickness T has the meaning of the thickness of the adhesive layer, the area S has the meaning of the area (length 20 mm×width 20 mm) of the aluminum electrode, and the vacuum permittivity ε₀ has the meaning of a physical constant (8.854×10⁻¹² F/m).

The minimum value and the maximum value were selected from the calculated relative permittivity and the temperature dependency (%) was obtained from the Equation [(maximum value−minimum value)/minimum value×100].

Here, the adjustment of the temperature was carried out using a liquid nitrogen cooling stage in the case of low temperatures and using a hot plate in the case of high temperatures.

(False Operation Evaluation Method)

The touch panel which was produced as described above was left at room temperature and normal humidity for 4 hours after being left under conditions of 85° C. and 85% RH for 24 hours. Next, the temperature of the touch panel on which a high humidity and high temperature treatment was carried out was increased by 20° C. from −40° C. to 80° C. in stages and the false operation generation ratio when touched at each temperature was measured. That is, in environments of −40° C., −20° C., 0° C., 20° C., 40° C., 60° C., and 80° C., an arbitrary place was touched 100 times and the false operation generation ratio (%) of the touch panel [(frequency of not reacting normally/100)×100] was measured from the frequency at which the touch panel did not react normally.

The maximum value was calculated from the measured false operation generation ratio at each temperature and evaluation was carried out by setting OK in a case where the value was less than 10% and NG in a case of 10% or more. The results are shown in Table 1.

In Table 1, the “content of (meth)acrylate X” indicates the content (mass %) of (meth)acrylate X with respect to the total mass of the (meth)acrylate compound.

In Table 1, “ester group mass ratio EX which is derived from (meth)acrylate X” indicates the value of the ester group mass ratio EX which is represented by Equation (1) described above.

In Table 1, the “content of (meth)acrylate Y” indicates the content (mass %) of (meth)acrylate Y with respect to the total mass of the (meth)acrylate compound.

In Table 1, “ester group mass ratio EY which is derived from (meth)acrylate Y” indicates the value of the ester group mass ratio EY which is represented by Equation (2) described above.

In Table 1, “ΣRep” indicates a value which is obtained from Equation (3) described above.

In Table 1, “ΣRbc” indicates a value which is obtained from Equation (4) described above.

In the “presence or absence of a urethane bond, a urea bond, an amide bond, and an alkyl substituted amino group in a polymer” section in Table 1, “present” indicates a case where a urethane bond, a urea bond, an amide bond, or an alkyl substituted amino group is included in poly(meth)acrylate and “absent” indicates a case where none of the above are included in poly(meth)acrylate.

In Table 1, the “temperature dependency” indicates the temperature dependency of the relative permittivity of the adhesive layer which is obtained from the temperature dependency evaluation test described above.

In Table 1, the “maximum value of relative permittivity” indicates the maximum value of the relative permittivity of the adhesive layer at each temperature every 20° C. from −40° C. to 80° C.

In Table 1, in the “detection electrodes”, “silver” indicates a case where the detection electrodes in the capacitance touch panel sensor are formed by silver wires and “ITO” indicates a case of being formed of ITO.

Here, in Synthesis Examples 1 to 10 described above, since the acid value and the hydroxyl number of the monomer which is used was 0 mgKOH/g, the acid value and the hydroxyl number of poly(meth)acrylate in the adhesive layer which was obtained in Synthesis Examples 1 to 10 described above were also 0 mgKOH/g.

In addition, in Synthesis Examples 1 to 9 and 11 described above, a urethane bond, a urea bond, an amide bond, and an alkyl substituted amino group were not included in the poly(meth)acrylate in the obtained adhesive layer.

Furthermore, in Table 1, ΣRep is not calculated since (meth)acrylate X is not used in the Comparative Examples 2, 5, and 6. Here, in Table 1, this is indicated as “-”.

TABLE 1

| | | | Adhesive Layer | | | | | |
|---|---|---|---|---|---|---|---|---|
| | | | Structural factor | | | | | |
| | | | Content ratio | | Content ratio | | | |
| | | | of | Ester group | of | Ester group | | |
| | | Type of | (meth)acrylate | mass ratio EX | (meth)acrylate | mass ratio EY | | |
| | | adhesive | X in total | derived from | Y in total | derived from | (meth)acrylate | (meth)acrylate |
| | | film | (meth)acrylate | (meth)acrylate X | (meth)acrylate | (meth)acrylate Y | X ΣRep | Y ΣRbe |
| Example 1 | Synthesis | S-01 | 39.2% | 8.3% | 60.8% | 13.8% | 0.30 | 0.10 |
| | Example 1 | | | | | | | |
| Example 2 | Synthesis | S-02 | 27.8% | 5.9% | 63.9% | 14.5% | 0.30 | 0.10 |
| | Example 2 | | | | | | | |
| Example 3 | Synthesis | S-03 | 36.1% | 7.6% | 63.9% | 12.8% | 0.30 | 0.08 |
| | Example 3 | | | | | | | |
| Example 4 | Synthesis | S-04 | 37.1% | 7.9% | 62.9% | 12.5% | 0.30 | 0.06 |
| | Example 4 | | | | | | | |
| Example 5 | Synthesis | S-05 | 39.2% | 8.3% | 60.8% | 13.7% | 0.35 | 0.10 |
| | Example 5 | | | | | | | |
| Example 6 | Synthesis | S-06 | 40.2% | 8.5% | 59.8% | 13.6% | 0.35 | 0.10 |
| | Example 6 | | | | | | | |
| Example 7 | Synthesis | S-07 | 40.2% | 8.4% | 59.8% | 13.6% | 0.35 | 0.10 |
| | Example 7 | | | | | | | |
| Example 8 | Synthesis | S-08 | 35.1% | 7.1% | 64.9% | 14.1% | 0.33 | 0.09 |
| | Example 8 | | | | | | | |
| Example 9 | Synthesis | S-01 | 39.2% | 8.3% | 60.8% | 13.8% | 0.30 | 0.10 |
| | Example 1 | | | | | | | |
| Comparative | Synthesis | S-11 | 42.9% | 9.1% | 57.1% | 13.2% | 0.30 | 0.11 |
| Example 1 | Example 9 | | | | | | | |
| Comparative | Synthesis | S-12 | 0.0% | 0.0% | 100% | 23.9% | — | 0.12 |
| Example 2 | Example | | | | | | | |
| | 10 | | | | | | | |
| Comparative | Synthesis | S-13 | 30.6% | 6.1% | 53.1% | 12.7% | 0.30 | 0.13 |
| Example 3 | Example | | | | | | | |
| | 11 | | | | | | | |
| Comparative | Synthesis | S-14 | 25.8% | 5.5% | 61.9% | 14.2% | 0.30 | 0.11 |
| Example 4 | Example | | | | | | | |
| | 12 | | | | | | | |
| Comparative | Synthesis | S-15 | 0.0% | 0.0% | 79.0% | 16.4% | — | 0.10 |
| Example 5 | Example | | | | | | | |
| | 13 | | | | | | | |
| Comparative | Synthesis | S-16 | 0.0% | 0.0% | 79.0% | 16.4% | — | 0.10 |
| Example 6 | Example | | | | | | | |
| | 14 | | | | | | | |
| Comparative | Synthesis | S-17 | 44.2% | 9.4% | 55.8% | 12.9% | 0.30 | 0.11 |
| Example 7 | Example | | | | | | | |
| | 15 | | | | | | | |
| Comparative | Synthesis | S-11 | 42.9% | 9.1% | 57.1% | 13.2% | 0.30 | 0.11 |
| Example 8 | Example 9 | | | | | | | |

| | Adhesive Layer | | | | | | | |
|---|---|---|---|---|---|---|---|---|
| | Structural factor | | | | | | | |
| | | Presence | | | | | | |
| | | or absence | | | | | | |
| | | of | | | | | | |
| | | urethane | | | | | | |
| | | bond, urea | | | | | | |
| | | bond, | | | | | | |
| | | amide | | | | | | |
| | | bond, and | | | | | | |
| | | alkyl | Physical value | | | Touch sensor characteristics | | |
| | | substituted | Hydroxyl | | Maximum | | False | |
| | (meth)acrylate | amino | number and | | value of | | operation | False |
| | X/(meth)acrylate | group in | acid value | Temperature | relative | Detection | generation | operation |
| | Y ΣRecal | polymer | (mgKOH/g) | dependency | permittivity | electrodes | ratio | evaluation |
| Example 1 | 0.60 | Absent | 0.0 | 19% | 3.20 | Silver | 7.5% | OK |
| Example 2 | 0.41 | Absent | 0.0 | 18% | 3.10 | Silver | 8.0% | OK |
| Example 3 | 0.59 | Absent | 0.0 | 21% | 3.30 | Silver | 7.8% | OK |
| Example 4 | 0.63 | Absent | 0.0 | 20% | 3.25 | Silver | 8.0% | OK |
| Example 5 | 0.61 | Absent | 0.0 | 20% | 3.26 | Silver | 5.2% | OK |
| Example 6 | 0.63 | Absent | 0.0 | 20% | 3.22 | Silver | 5.8% | OK |
| Example 7 | 0.62 | Absent | 0.0 | 19% | 3.19 | Silver | 6.2% | OK |
| Example 8 | 0.50 | Absent | 0.0 | 20% | 3.24 | Silver | 7.8% | OK |
| Example 9 | 0.60 | Absent | 0.0 | 20% | 3.22 | ITO | 8.5% | OK |
| Comparative | 0.69 | Absent | 0.0 | 21% | 3.30 | Silver | 10% | NG |
| Example 1 | | | | | | | | |
| Comparative | 0.00 | Present | 0.0 | 25% | 3.42 | Silver | 12% | NG |
| Example 2 | | | | | | | | |
| Comparative | 0.48 | Absent | 77.3 | 33% | 4.59 | Silver | 18% | NG |
| Example 3 | | | | | | | | |
| Comparative | 0.38 | Present | 7.2 | 26% | 3.40 | Silver | 16% | NG |
| Example 4 | | | | | | | | |
| Comparative | 0.00 | Present | 3.9 | 24% | 3.36 | Silver | 13% | NG |
| Example 5 | | | | | | | | |
| Comparative | 0.00 | Present | 3.9 | 25% | 3.40 | Silver | 13% | NG |
| Example 6 | | | | | | | | |
| Comparative | 0.73 | Present | 3.8 | 31% | 3.50 | Silver | 18% | NG |
| Example 7 | | | | | | | | |
| Comparative | 0.69 | Absent | 0.0 | 22% | 3.29 | ITO | 16% | NG |
| Example 8 | | | | | | | | |

As shown in Table 1, in a case of using the laminate for a touch panel of the present invention, the generation of false operations in the touch panel was suppressed. In particular, better effects were obtained in Examples 5 to 7 in which (ΣRep) was 0.34 to 0.37.

On the other hand, the desired effects were not obtained in a case of using a laminate for a touch panel which does not satisfy predetermined conditions.

### EXPLANATION OF REFERENCES

10, 10a: laminate for touch panel
12: adhesive layer
14: capacitance touch panel sensor
16: protective substrate
18: display apparatus
20: capacitance touch panel
22: substrate
24, 24a: first detection electrodes
26: first lead-out wire
28, 28a: second detection electrodes
30: second lead-out wire
32: flexible printed wiring board
34: conductive thin wires
36: grid
38: first substrate
40: adhesive layer
42: second substrate
100: aluminum electrode
180, 180a, 280, 380: capacitance touch panel sensor

What is claimed is:

1. A laminate for a touch panel comprising:
an adhesive layer; and
a capacitance touch panel sensor,
wherein the adhesive layer includes a poly(meth)acrylate which is formed by polymerizing a (meth)acrylate compound and which has a polycyclic aliphatic hydrocarbon group and a saturated chain hydrocarbon group,
the (meth)acrylate compound includes at least one type or two or more types of (meth)acrylate X which is represented by Formula (X) and which has a polycyclic aliphatic hydrocarbon group with 7 to 30 carbon atoms and one type or two or more types of (meth)acrylate Y which is represented by Formula (Y) and which has a saturated chain hydrocarbon group with 8 to 30 carbon atoms,
a content of the (meth)acrylate X is 25.0 mass % to 41.0 mass % with respect to a total mass of the (meth)acrylate compound,
a content of the (meth)acrylate Y is 58.0 mass % to 70.0 mass % with respect to a total mass of the (meth)acrylate compound,
an ester group mass ratio EX which is represented by Equation (1) described below is 5.0 mass % to 9.0 mass %,
an ester group mass ratio EY which is represented by Equation (2) described below is 12.0 mass % to 18.0 mass %,
an acid value and a hydroxyl number of the poly(meth)acrylate is 0 mgKOH/g,
the poly(meth)acrylate does not include a urethane bond, a urea bond, an amide bond, or an alkyl substituted amino group,
the adhesive layer does not include polyurethane and polyurea,
a temperature dependency of relative permittivity of the adhesive layer which is obtained from a temperature dependency evaluation test described below is 30% or less, and a maximum value of relative permittivity at each temperature every 20° C. from −40° C. to 80° C. is 3.5 or less, 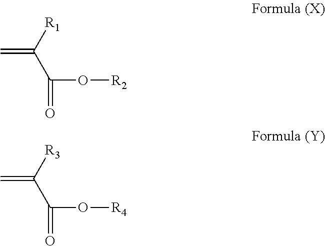
$$\begin{matrix}EX ( \% ) = {\sum }_{i = 1}^{n} ( RXi \times WXi ) & Equation ( 1 ) \\ EY ( \% ) = {\sum }_{i = 1}^{m} ( RYi \times WYi ) & Equation ( 2 )\end{matrix}$$
in Formula (X), R₁ represents a hydrogen atom or an alkyl group, and R₂ represents a polycyclic aliphatic hydrocarbon group with 7 to 30 carbon atoms,
in Formula (Y), R₃ represents a hydrogen atom or an alkyl group, and R₄ represents a saturated chain hydrocarbon group with 8 to 30 carbon atoms,
in Equation (1), n represents the number of types of the (meth)acrylate X, RXi indicates a ratio of a molecular weight of an ester group (—COO—) in the i-th (meth)acrylate X with respect to a total molecular weight of the i-th type of (meth)acrylate X, WXi indicates a mass ratio (%) of the i-th (meth)acrylate X with respect to a total mass of the (meth)acrylate compound, and, here, a ratio of the molecular weight of the ester group (—COO—) in the i-th (meth)acrylate X is represented by a molecular weight of ester group/total molecular weight of i-th (meth)acrylate X,
in Equation (2), m represents a number of types of the (meth)acrylate Y, RYi indicates a ratio of a molecular weight of an ester group (—COO—) in i-th (meth)acrylate Y with respect to a total molecular weight of the i-th type (meth)acrylate Y, WYi indicates a mass ratio (%) of the i-th (meth)acrylate Y with respect to a total mass of the (meth)acrylate compound, and, here, a ratio of the molecular weight of the ester group (—COO—) in the i-th (meth)acrylate Y is represented by molecular weight of ester group/total molecular weight of i-th (meth)acrylate Y, and
a temperature dependency evaluation test is a test in which an adhesive layer is interposed between aluminum electrodes, temperature is increased from −40° C. to 80° C. by 20° C. each time, a relative permittivity of the adhesive layer is calculated by impedance measurement at 1 MHz at each temperature, a minimum value and a maximum value are selected from the calculated relative permittivity at each temperature, and a value (%) which is obtained from Equation [(maximum value−minimum value)/minimum value×100] is the temperature dependency.

2. The laminate for a touch panel according to claim 1,
wherein a total ratio (ΣRep) of tertiary carbon atoms and quaternary carbon atoms which are included in a cyclic structure in the polycyclic aliphatic hydrocarbon group and which is represented by Equation (3) is 0.29 to 0.37,
a total ratio (ΣRbc) of tertiary carbon atoms and quaternary carbon atoms which are included in the saturated chain hydrocarbon group and which is represented by Equation (4) is 0.04 to 0.12,
$$\begin{matrix}\sum Rep = {\sum }_{i = 1}^{n} ( PXi \times MXi ) & Equation ( 3 ) \\ \sum Rbc = {\sum }_{i = 1}^{m} ( PYi \times MYi ) & Equation ( 4 )\end{matrix}$$
in Equation (3), n represents the number of types of the (meth)acrylate X, PXi indicates a ratio (Ne/Np) of the i-th type (meth)acrylate X, the ratio (Ne/Np) is a ratio (Ne/Np) of a total number (Ne) of tertiary carbon atoms and quaternary carbon atoms which are included in a cyclic structure in the polycyclic aliphatic hydrocarbon group with respect to a total number of carbon atoms (Np) which are included in the polycyclic aliphatic hydrocarbon group, however, in Formula (X), tertiary carbon atoms or quaternary carbon atoms which are bonded with oxygen atoms which are adjacent to R₂ are excluded from the tertiary carbon atoms and quaternary carbon atoms which are included in a cyclic structure in the polycyclic aliphatic hydrocarbon group, MXi indicates a molar ratio of the i-th (meth)acrylate X with respect to a total molar amount of (meth)acrylate X, and, here, a molar ratio of the i-th (meth)acrylate X is represented by a molar amount of i-th (meth)acrylate X/total molar amount of (meth)acrylate X, and
in Equation (4), m represents the number of types of the (meth)acrylate Y, PYi indicates a ratio (Nb/Nc) of i-th type (meth)acrylate Y, the ratio (Nb/Np) is a ratio (Nb/Nc) of a total number (Nb) of tertiary carbon atoms and quaternary carbon atoms which are included in the saturated chain hydrocarbon group with respect to a total number of carbon atoms (Nc) which are included in the saturated chain hydrocarbon group, MYi indicates a molar ratio of i-th (meth)acrylate Y with respect to a total molar amount of (meth)acrylate Y, and, here, a molar ratio of the i-th (meth)acrylate Y is represented by molar amount of i-th (meth)acrylate Y/total molar amount of (meth)acrylate Y.

3. The laminate for a touch panel according to claim 1,
wherein in Formula (X), R₂ represents a polycyclic aliphatic hydrocarbon group of which carbon atoms which are bonded with oxygen atoms which are adjacent to R₂ are tertiary carbon atoms or quaternary carbon atoms,
the (meth)acrylate Y includes (meth)acrylate Z in which R₄ is a straight-chain alkyl group with 8 to 30 carbon atoms and (meth)acrylate W in which R₄ is a branched chain alkyl group with 8 to 30 carbon atoms, and
in the (meth)acrylate Z, an alkylene group which is represented by —(CH₂)ₘ— is included between tertiary carbon atoms or quaternary carbon atoms which are included in the branched chain alkyl group which is represented by R₄ and oxygen atoms which are adjacent to R₄.

4. The laminate for a touch panel according to claim 1,
wherein a molar ratio of the (meth)acrylate X to the (meth)acrylate Y is 0.40 to 0.67, and
here, the molar ratio is represented by molar amount of (meth)acrylate X/molar amount of (meth)acrylate Y.

5. The laminate for a touch panel according to claim 2,
wherein a total ratio (ΣRep) of tertiary carbon atoms and quaternary carbon atoms which are included in a cyclic structure in the polycyclic aliphatic hydrocarbon group is 0.34 to 0.37.

6. The laminate for a touch panel according to claim 1,
wherein the adhesive layer is formed by a photocuring treatment.

7. The laminate for a touch panel according to claim 1,
wherein the capacitance touch panel sensor comprises a substrate and an electrode which is arranged at least on one surface of the substrate, and
the electrode includes a mesh form which is formed of a grid which is formed by conductive thin wire.

8. The laminate for a touch panel according to claim 7,
wherein the conductive thin wire is formed of silver thin wire.

9. The laminate for a touch panel according to claim 7,
wherein the electrodes are arranged on both sides of the substrate.

10. A flat panel display comprising:
the laminate for a touch panel according to claim 1; and
a display apparatus.

11. The laminate for a touch panel according to claim 2,
wherein in Formula (X), R₂ represents a polycyclic aliphatic hydrocarbon group of which carbon atoms which are bonded with oxygen atoms which are adjacent to R₂ are tertiary carbon atoms or quaternary carbon atoms,
the (meth)acrylate Y includes (meth)acrylate Z in which R₄ is a straight-chain alkyl group with 8 to 30 carbon atoms and (meth)acrylate W in which R₄ is a branched chain alkyl group with 8 to 30 carbon atoms, and
in the (meth)acrylate Z, an alkylene group which is represented by —(CH₂)ₘ— is included between tertiary carbon atoms or quaternary carbon atoms which are included in the branched chain alkyl group which is represented by R₄ and oxygen atoms which are adjacent to R₄.

12. The laminate for a touch panel according to claim 2,
wherein a molar ratio of the (meth)acrylate X to the (meth)acrylate Y is 0.40 to 0.67, and
here, the molar ratio is represented by molar amount of (meth)acrylate X/molar amount of (meth)acrylate Y.

13. The laminate for a touch panel according to claim 3,
wherein a molar ratio of the (meth)acrylate X to the (meth)acrylate Y is 0.40 to 0.67, and
here, the molar ratio is represented by molar amount of (meth)acrylate X/molar amount of (meth)acrylate Y.

14. The laminate for a touch panel according to claim 3,
wherein a total ratio (ΣRep) of tertiary carbon atoms and quaternary carbon atoms which are included in a cyclic structure in the polycyclic aliphatic hydrocarbon group is 0.34 to 0.37.

15. The laminate for a touch panel according to claim 4,
wherein a total ratio (ΣRep) of tertiary carbon atoms and quaternary carbon atoms which are included in a cyclic structure in the polycyclic aliphatic hydrocarbon group is 0.34 to 0.37.

16. The laminate for a touch panel according to claim 2,
wherein the adhesive layer is formed by a photocuring treatment.

17. The laminate for a touch panel according to claim 3,
wherein the adhesive layer is formed by a photocuring treatment.

18. The laminate for a touch panel according to claim 4,
wherein the adhesive layer is formed by a photocuring treatment.

19. The laminate for a touch panel according to claim 5,
wherein the adhesive layer is formed by a photocuring treatment.

20. The laminate for a touch panel according to claim 2,
wherein the capacitance touch panel sensor comprises a substrate and an electrode which is arranged at least on one surface of the substrate, and
the electrode includes a mesh form which is formed of a grid which is formed by conductive thin wire.
